(19) United States
(12) Patent Application Publication
(10) Pub. No.: US 2022/0391916 A1
(43) Pub. Date: Dec. 8, 2022

(54) SYSTEM AND METHOD TO PROVIDE DATA-DRIVEN DYNAMIC RECOMMENDATIONS DURING EQUIPMENT MAINTENANCE LIFECYCLE

(71) Applicant: Jinesh Nirad Varia, Bothell, WA (US)

(72) Inventor: Jinesh Nirad Varia, Bothell, WA (US)

(21) Appl. No.: 17/819,042

(22) Filed: Aug. 11, 2022

Related U.S. Application Data
(63) Continuation-in-part of application No. 16/993,642, filed on Aug. 14, 2020, now abandoned.

(51) Int. Cl. G06Q 30/00; G06Q 30/02

(52) U.S. Cl. CPC G06Q 30/012; G06Q 30/0185; G06Q 30/0207

(57) ABSTRACT

A system and method to provide data-driven dynamic recommendations for equipment maintenance lifecycles is disclosed. The method includes detecting one or more authenticated components and one or more authenticated services of utility equipment and obtaining usage data, utility parameters, events, and timing of the events. Further, the method includes generating a weight profile and an asset score associated with the utility equipment. Furthermore, the method includes predicting a rate of variation of the asset score by using a variation prediction-based AI model, determining a health condition of the utility equipment, updating dynamic incentives, generating notifications corresponding to the dynamic incentives, and outputting the notifications and the rate of variation on a user interface screen of electronic devices associated with the users.

### CROSS-REFERENCE TO RELATED APPLICATIONS

This Application is a continuation in part of a non-provisional patent application filed in the US having patent application Ser. No. 16/993,642, filed on Aug. 14, 2020 and titled “SYSTEM AND METHOD TO PROVIDE WARRANTY FOR A UTILITY EQUIPMENT”.

### FIELD OF INVENTION

Embodiments of the present disclosure relate to equipment management and more particularly relate to a system and method to provide data-driven dynamic recommendations for equipment maintenance lifecycle.

### BACKGROUND

Original Equipment Manufacturers (OEMs) and distributors offer standard fixed—term manufacturer's warranty for sales of one or more equipment. Such manufacturer's warranties typically last for a definite period of time. During the course of equipment lifetime, one or more customers typically purchases various authenticated components or spare parts or consumables and maintenance services directly from the manufacturers or authorized distributors. Generally, after an expiration of the warranty, the one or more customers do not attempt to purchase the genuine components or service from the one or more manufacturers or the authorized distributors and use counterfeit parts or service in order to reduce their operational costs. As a result, the OEMs lose on aftermarket sales for remaining lifetime of the one or more equipment. Further, to cope up with business of the OEMs, various conventional systems are available in market which offers multiple types of maintenance and warranty programs to generate after-sales revenue.

Further, the conventional systems offering the maintenance and warranty programs to the one or more customers include extended warranty programs or annual maintenance contracts for the authenticated components of the one or more equipment to manage the after sales revenue of the OEMs. However, such conventional systems offer the extended warranty programs and maintenance contracts in exchange of money from the one or more customers. Also, such extended warranty programs and maintenance contracts are offered to the one or more customers at the time of purchasing of the one or more equipment. These programs are not specific/personalized or customized after looking at the condition of the equipment. Moreover, the conventional systems are unable to track usage of the authenticated components or recommended maintenance services which are purchased by the one or more customers for the one or more equipment. Also, the conventional systems are unable to enforce usage of the authenticated components to the one or more customers. Thus, the one or more customers start using the counterfeit parts or consumables. The use of the counterfeit parts leads to damage and destruction of the one or more equipment. Further, the use of the counterfeit parts poses a significant health and safety threat to the one or more customers. Generally, the counterfeit parts are of a lower quality as compared to the authenticated components. Thus, the counterfeit parts usually lead to increased downtime of the one or more equipment, and huge replacement costs. In addition, the conventional systems also fail to accurately monitor and track the usage of the authenticated parts installed on the equipment and how it impacts the overall operations, efficiency, performance and safety of the equipment. Due to the lack of visibility, the customers or owners of the one or more equipment have no tangible incentive to purchase authenticated parts and service from the OEM or authorized distributor.

Hence, there is a need for an improved system and method to provide data-driven dynamic recommendations for equipment maintenance lifecycle. The system and method is also needed to track usage of authenticated parts of a utility equipment and providing an incentive that is automatically computed based on the usage data, to the customers, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system to provide data-driven dynamic recommendations for equipment maintenance lifecycle is disclosed. The computing system includes one or more hardware processors and a memory coupled to the one or more hardware processors. The memory includes a plurality of modules in the form of programmable instructions executable by the one or more hardware processors. The plurality of modules include a data detection module configured to detect at least one of: one or more authenticated components and one or more authenticated services of a utility equipment for uniqueness and compliance by scanning a unique encrypted code associated with each of the at least one of: the one or more authenticated components and the one or more authenticated services by using one or more automated detection means. The plurality of modules include a data obtaining module configured to obtain usage data associated with the detected at least one of: the one or more authenticated components and the one or more authenticated services via one or more communication platforms upon detecting the at least one of: the one or more authenticated components and the one or more authenticated services. The one or more communication platforms use one or more sensors to receive the usage data via one or more communication technologies. Further, the data obtaining module obtains one or more utility parameters associated with the utility equipment from a storage unit and an external Application Programming Interface (API) based on the obtained usage data. The one or more utility parameters include a model of the utility equipment, name of the utility equipment, age of the utility equipment, location of the utility equipment, temperature, humidity, speed, location, run hours, and name of user of the utility equipment. The data obtaining module obtains one or more events and a timing of the one or more events associated with the utility equipment from the storage unit based on the obtained usage data and the obtained one or more utility parameters. The one or more events include at least one of: one or more periodic scheduled maintenance events, one or more repair events, one or more accident events, one or more audit events, one or more financial events and one or more routing maintenance events. Further, the plurality of modules include a data computation module configured to generate a weight profile associated with the obtained one or more events and the obtained timing of the one or more events based on a set of weight generation rules, the obtained usage data, the obtained one or more utility parameters, one or more score parameters and one or more scheduled event timings. The one or more score parameters include at least one of: telemetry of the utility equipment, ambient conditions, one of: operator's handling skill and performance and timely maintenance of the utility equipment from an authorized certified personnel. The data computation module generates an asset score associated with the utility equipment based on the obtained usage data, the ambient conditions, the obtained one or more utility parameters, the generated weight profile, and the one or more score parameters. Furthermore, the plurality of modules include a data prediction module configured to predict a rate of variation of the asset score associated with the timings of the one or more events of the utility equipment based on a plurality of historical asset scores, one or more new events, the generated weight profile, and the generated asset score by using a variation prediction-based Artificial Intelligence (AI) model. The rate of variation includes one of: an incremental rate and a decremental rate of the asset score. The plurality of modules include a health condition determination module configured to determine a health condition of the utility equipment based on the generated weight profile, the generated asset score, and the predicted rate of variation by using a health condition-based AI model. The health condition of the utility equipment is one of: good performance, average performance, low performance, overheated, low risk, and high risk. The plurality of modules include a data incentive module configured to update one or more dynamic incentives associated with the at least one of: the one or more authenticated components and the one or more authenticated services dynamically based on the predicted rate of variation of the asset score and a set of dynamic incentive rules. The one or more dynamic incentives include at least one of: a warranty period and one or more terms and conditions in a warranty document, a rebate, a discount, a coupon, a virtual cash, a redeem point, a price training, and a resale value. Further, the plurality of modules include a notification generation module configured to generate one or more notifications corresponding to the updated one or more dynamic incentives. The plurality of modules include a data output module configured to output the generated one or more notifications, the predicted rate of variation and the determined health condition on user interface screen of one or more electronic devices associated with one or more users via one or more communication channels. The one or more communication channels include a Short Message Service (SMS), a multimedia message, a push notification, and an email.

In accordance with another embodiment of the present disclosure, a method to provide data-driven dynamic recommendations for equipment maintenance lifecycle is disclosed. The method includes detecting at least one of: one or more authenticated components and one or more authenticated services of a utility equipment for uniqueness and compliance by scanning a unique encrypted code associated with each of the at least one of: the one or more authenticated components and the one or more authenticated services by using one or more automated detection means. The method further includes obtaining usage data associated with the detected at least one of: the one or more authenticated components and the one or more authenticated services via one or more communication platforms upon detecting the at least one of: the one or more authenticated components and the one or more authenticated services. The one or more communication platforms use one or more sensors to receive the usage data via one or more communication technologies. Further, the method includes obtaining one or more utility parameters associated with the utility equipment from a storage unit and an external API based on the obtained usage data. The one or more utility parameters include a model of the utility equipment, name of the utility equipment, age of the utility equipment, location of the utility equipment, temperature, humidity, speed, location, run hours, and name of user of the utility equipment. Also, the method includes obtaining one or more events and a timing of the one or more events associated with the utility equipment from the storage unit based on the obtained usage data and the obtained one or more utility parameters. The one or more events include at least one of: one or more periodic scheduled maintenance events, one or more repair events, one or more accident events, one or more audit events, one or more financial events and one or more routing maintenance events. Further, the method includes generating a weight profile associated with the obtained one or more events and the obtained timing of the one or more events based on a set of weight generation rules, the obtained usage data, the obtained one or more utility parameters, one or more score parameters and one or more scheduled event timings. The one or more score parameters include at least one of: telemetry of the utility equipment, ambient conditions, one of: operator's handling skill and performance and timely maintenance of the utility equipment from an authorized certified personnel. The method includes generating an asset score associated with the utility equipment based on the obtained usage data, the ambient conditions, the obtained one or more utility parameters, the generated weight profile and the one or more score parameters. Further, the method includes predicting a rate of variation of the asset score associated with the timings of the one or more events of the utility equipment based on a plurality of historical asset scores, one or more new events, the generated weight profile, and the generated asset score by using a variation prediction-based AI model. The rate of variation includes one of: an incremental rate and a decremental rate of the asset score. The method includes determining a health condition of the utility equipment based on the generated weight profile, the generated asset score, and the predicted rate of variation by using a health condition-based AI model. The health condition of the utility equipment is one of: good performance, average performance, low performance, overheated, low risk, and high risk. The method includes updating one or more dynamic incentives associated with the at least one of: the one or more authenticated components and the one or more authenticated services dynamically based on the predicted rate of variation of the asset score and a set of dynamic incentive rules. The one or more dynamic incentives include at least one of: a warranty period and one or more terms and conditions in a warranty document, a rebate, a discount, a coupon, a virtual cash, a redeem point, a price training, and a resale value. Furthermore, the method includes generating one or more notifications corresponding to the updated one or more dynamic incentives. The method includes outputting the generated one or more notifications, the predicted rate of variation and the determined health condition on user interface screen of one or more electronic devices associated with one or more users via one or more communication channels. The one or more communication channels include a Short Message Service (SMS), a multimedia message, a push notification and an email.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment to provide data-driven dynamic recommendations for equipment maintenance lifecycle, in accordance with an embodiment of the present disclosure;

FIG. 2 is a block diagram illustrating the exemplary computing system to provide recommendations for equipment maintenance lifecycle, in accordance with an embodiment of the present disclosure;

FIG. 3 is schematic representation of an exemplary embodiment of the computing system to facilitate management of the utility equipment, in accordance with an embodiment of the present disclosure;

FIG. 4 is schematic representation of an exemplary embodiment of the computing system to facilitate management of the utility equipment, in accordance with another embodiment of the present disclosure;

FIG. 5 is graphical user interface screen of the exemplary computing system to provide data-driven dynamic recommendations for equipment maintenance lifecycle, in accordance with an embodiment of the present disclosure;

FIG. 6 is a block diagram illustrating an exemplary process for adding a verified transaction to a blockchain, in accordance with an embodiment of the present disclosure; and

FIG. 7 is a process flow diagram illustrating an exemplary method to provide data-driven dynamic recommendations for equipment maintenance lifecycle, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

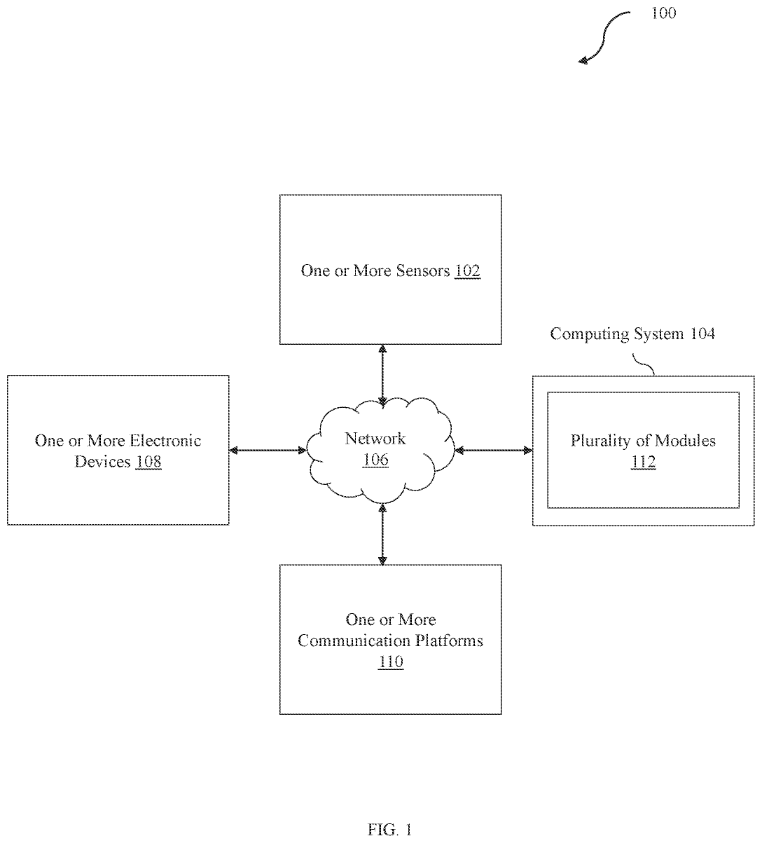

Referring now to the drawings, and more particularly to FIG. 1 through FIG. 7, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 to provide data-driven dynamic recommendations for equipment maintenance lifecycle, in accordance with an embodiment of the present disclosure. According to FIG. 1, the computing environment 100 includes one or more sensors 102 communicatively coupled to a computing system 104 via a network 106. The one or more sensors 102 are used to receive usage data via one or more communication technologies. For example, the one or more sensors 102 include water pressure sensors, temperature sensors and the like. In an embodiment of the present disclosure, the computing system 104 may be hosted on a central server, such as cloud server or a remote server. Further, the network 106 may be internet or any other wireless network.

Further, the computing environment 100 includes one or more electronic devices 108 associated with one or more users communicatively coupled to the computing system 104 via the network 106. The one or more electronic devices 108 are used by the one or more users to receive one or more notifications corresponding to updated one or more dynamic incentives and a predicted rate of variation. In an exemplary embodiment of the present disclosure, the one or more electronic devices 108 may include a laptop computer, desktop computer, tablet computer, smartphone, wearable device, smart watch, and the like.

Further, the computing environment 100 includes one or more communication platforms 110 communicatively coupled to the computing system 104 via the network 106. In an embodiment of the present disclosure, the one or more communication platforms 110 are used to obtain the usage data associated with one or more authenticated components, one or more authenticated services or a combination thereof. In an embodiment of the present disclosure, the one or more communication platforms 110 include a gateway, an application platform and the like.

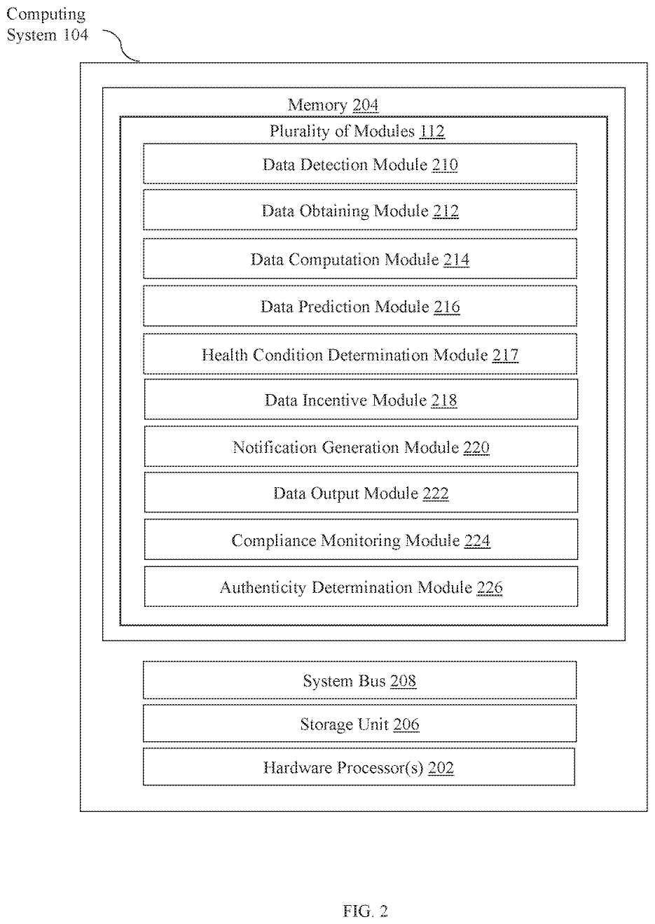

Furthermore, the one or more electronic devices 108 include a local browser, a mobile application, or a combination thereof. The one or more users may use a web application via the local browser, the mobile application, or a combination thereof to communicate with the computing system 104. In an embodiment of the present disclosure, the computing system 104 includes a plurality of modules 112. Details on the plurality of modules 112 have been elaborated in subsequent paragraphs of the present description with reference to FIG. 2.

In an embodiment of the present disclosure, the computing system 104 is configured to detect the one or more authenticated components, the one or more authenticated services or a combination thereof of the utility equipment for uniqueness and compliance by scanning a unique encrypted code associated with each of the one or more authenticated components, the one or more authenticated services or a combination by using one or more automated detection means. Further, the computing system 104 obtains the usage data associated with the detected one or more authenticated components, the detected one or more authenticated services or a combination thereof via the one or more communication platforms 110 upon detecting the one or more authenticated components, the one or more authenticated services or a combination thereof. The computing system 104 obtains one or more utility parameters associated with the utility equipment from a storage unit and an external Application Programming Interface (API) based on the obtained usage data. The computing system 104 obtains one or more events and a timing of the one or more events associated with the utility equipment from the storage unit based on the obtained usage data and the obtained one or more utility parameters. Furthermore, the computing system 104 generates a weight profile associated with the obtained one or more events and the obtained timing of the one or more events based on a set of weight generation rules, the obtained usage data, the obtained one or more utility parameters, one or more score parameters and one or more scheduled event timings. The computing system 104 generates an asset score associated with the utility equipment based on the obtained usage data, the ambient conditions, the obtained one or more utility parameters, the generated weight profile and the one or more score parameters. The computing system 104 also predicts a rate of variation of the asset score associated with the timings of the one or more events of the utility equipment based on a plurality of historical asset scores, one or more new events, the generated weight profile, and the generated asset score by using a variation prediction-based Artificial Intelligence (AI) model. The computing system determines a health condition of the utility equipment based on the generated weight profile, the generated asset score, and the predicted rate of variation by using a health condition-based AI model. The health condition of the utility equipment is good performance, average performance, low performance, overheated, low risk, or high risk. The computing system 104 updates one or more dynamic incentives associated with the one or more authenticated components, the one or more authenticated services or a combination thereof dynamically based on the predicted rate of variation of the asset score and a set of dynamic incentive rules. Furthermore, the computing system 104 generates one or more notifications corresponding to the updated one or more dynamic incentives. The computing system 104 outputs the generated one or more notifications, the predicted rate of variation and the determined health condition on user interface screen of the one or more electronic devices 108 associated with the one or more users via one or more communication channels.

FIG. 2 is a block diagram illustrating the exemplary computing system 104 to provide data-driven dynamic recommendations for equipment maintenance lifecycle, in accordance with an embodiment of the present disclosure. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 includes a data detection module 210, a data obtaining module 212, a data computation module 214, a data prediction module 216, a health condition determination module 217, a data incentive module 218, a notification generation module 220, a data output module 222, a compliance monitoring module 224 and an authenticity determination module 226.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

The storage unit 206 may be a cloud storage. The storage unit 206 may store the obtained usage data, the one or more utility parameters, the one or more events, the timing of the one or more events, the generated weight, the set of weight generation rules, the one or more scheduled event timings, the asset score, the rate of variation, the plurality of historical asset scores, the one or more new events, the set of dynamic incentives, a dynamic score, a dynamic resale value, a determined age, a prior purchase price and the like.

The data detection module 210 is configured to detect the one or more authenticated components, the one or more authenticated services or a combination thereof of the utility equipment for uniqueness and compliance by scanning the unique encrypted code associated with each of the one or more authenticated components, the one or more authenticated services or a combination thereof by using the one or more automated detection means. In an embodiment of the present disclosure, counterfeiting of the one or more authenticated components, the one or more authenticated services or a combination thereof may also be identified based on the detection of the one or more authenticated components, the one or more authenticated services or a combination thereof. For example, the one or more authenticated components include an industrial equipment, a component of a commercial equipment, a component of a consumer utility equipment or a combination thereof. For example, the one or more authenticated components may also include filters, lubricants, spare parts, engine, compressor, motors, pumps, blades, brakes, battery, and the like. In an exemplary embodiment of the present disclosure, the utility equipment may include a heavy machine vehicle like trucks, tree-shaker, railway maintenance or construction and material handling portable machines, a consumer electronic product, a portable or stationary industrial machine such as compressors, chillers, and the like. In embodiment of the present disclosure, the one or more authenticated services are maintenance services performed at an authorized and certified technician, distributor, dealer, and the like. For example, if it is detected that an oil change is done at a non-authorized service center. The event of oil change at the non-authorized service center is weighed lower than the oil change at an authorized service center. But it is weighed more as compared to someone who did not perform the event of an oil change at all or did it late.

In an embodiment of the present disclosure, the one or more detection means include one or more wired detection means, one or more wireless detection means or a combination thereof. For example, the one or more wired detection means may include 1-Wire protocol device or a bar code scanning device. In an embodiment of the present disclosure, the one or more wireless detection means may include an application of the computing system 104 for reading the unique encrypted code embedded in a Near-Field Communication (NFC) tag, a Radio-Frequency Identification (RFID) tag or Bluetooth Low Energy (BLE) tag, or a wired sensor or touch technology like Electrically Erasable Programmable Read-Only Memory (EEPROM), and the like. In an embodiment of the present disclosure, the unique encrypted code of the one or more authenticated components, the one or more authenticated services or a combination thereof upon scanning is matched with a list of multiple unique encrypted codes associated with multiple authenticated components and multiple authenticated services stored in a component repository and service repository respectively to check the uniqueness of the scanned code. The matching is done to identify usage of the one or more authenticated components, the one or more authenticated services or a combination thereof and ensure that the unique encrypted code can be used only once in its lifetime. In an embodiment of the present disclosure, the usage of the one or more authenticated components, the one or more authenticated services or a combination thereof may be identified based on assets historical data by using the unique encrypted code. In an embodiment of the present disclosure, the assets historical data corresponds to the list of multiple unique encrypted codes in the storage unit 206. In a scenario, when the unique encrypted code is not present in the storage unit 206 or used earlier by anyone, then the one or more authenticated components, the one or more authenticated services or a combination thereof are not genuine. In another embodiment, the usage of the one or more authenticated components, the one or more authenticated services or a combination thereof is identified by using one or more artificial intelligence techniques in an absence of unique encrypted code or disconnection of the asset. In an embodiment of the present disclosure, pattern-matching technology is used to determine various parameters such as model, serial number, age, time, location of the one or more authenticated components, the one or more authenticated services or a combination thereof. For example, when the unique encrypted code or the asset/equipment is absent or lost, and it is detected that the one or more equipments are still running by sensor values, a multi-variate anomaly detection is used to detect anomalies and also use missing values imputation methods to fill missing values. For example, a filter is required when a compressor is running. When an unauthenticated filter is used, it does not send the unique encrypted code to the storage unit 206. Further, when an old-authenticated filter is used, it sends the code which is already matched. When it is detected that the compressor is still on by using various sensor values, it is known that either the compressor has installed a non-genuine part using multi-variate anomaly detection and past behavior or the user has not performed any maintenance at all. Furthermore, these changes the weight factor and the score. In an embodiment of the present disclosure, missing values imputations are determined to understand whether a filter is installed or not. If there is no method of determining the missing values imputations, it is flagged and the asset score is lowered. These AI techniques helps are used to intelligently authenticate a part, component or consumable. Further, the term ‘unique encrypted code’ is defined as a unique code associated with a component for representation of data in a visual and machine-readable form. For example, the unique encrypted code includes a bar code, a Quick Response (QR) code, an alphanumeric code, and the like. In an embodiment of the present disclosure, the unique encrypted code is detected by manually scanning the unique encrypted code during installation by using scanners, smart phones, and the like. In an embodiment of the present disclosure, the unique encrypted code is generated and stored in the storage unit 206. In such embodiment, the unique encrypted code is integrated or embedded with the one or more authenticated components, the one or more authenticated services or a combination thereof of the utility equipment.

The data obtaining module 212 is configured to obtain the usage data associated with the detected one or more authenticated components, the detected one or more authenticated services or a combination thereof via the one or more communication platforms 110 upon detecting the one or more authenticated components, the one or more authenticated services or a combination thereof. The usage data is obtained for transmission and storage to a cloud-based platform i.e., the storage unit 206. In an embodiment of the present disclosure, the one or more communication platforms 110 may include a gateway or an application platform. In such embodiment, the application platform may include a mobile application. In an embodiment of the present disclosure, the data obtaining module 212 collects the usage data of the one or more authenticated components, the one or more authenticated services or a combination thereof via the one or more communication platforms 110 for transmission of the usage data to the cloud-based platform in real time. The one or more communication platforms 110 collect the usage data of the one or more authenticated components, the one or more authenticated services or a combination thereof by the one or more users and transmits to the cloud-based platform. The cloud-based platform also includes a usage data storage repository which stores the usage data collected via the one or more communication platforms 110. In an exemplary embodiment of the present disclosure, the usage data may include data of usage of the one or more authenticated components in a predefined time period, data of usage of the one or more authenticated services in the predefined time period, data of usage of the utility equipment in a predefined geographical location, data of installation event, data of maintenance service performed, data of usage of the utility equipment based on guidance provided in a handbook or a combination thereof. In an embodiment of the present disclosure, the usage data also includes location i.e., latitude and longitude of the one or more authenticated components, the one or more authenticated services or a combination thereof, time of the event, installation type, and the like which are automatically captured. In an embodiment of the present disclosure, a firmware in the gateway captures these parameters and send it to the storage unit 206. In an exemplary embodiment of the present disclosure, the installation type may include factory install, replacement, repair, regular maintenance, and the like. Further, the usage data is sent along with the unique encrypted code and timestamp as payload to the storage unit 206. This payload is sent once or twice every day. In an embodiment of the present disclosure, the usage data of the one or more authenticated components may include usage of Bluetooth tags to see if the unique encrypted codes are unique, usage of the Bluetooth tags to see if the unique encrypted codes are compliant, reminders on lifetime and the like. In an embodiment of the present disclosure, the unique encrypted code is embedded inside the tag. In such embodiment, the usage of Bluetooth tags to see if the unique encrypted codes are unique may include the unique encrypted codes or filters which cannot be reused again, no one can clean the air filter or refill the ink in the old cartridge. In an embodiment of the present disclosure, once the unique encrypted code is transmitted to the storage unit 206 along with the timestamp in the payload, the timestamp is used to know when a component was installed and when it is getting expired based on the lifetime of that component. For example, an air filter is installed on time t1, air filter needs to be replaced every 3 months, an alert may be triggered after 3 months that air filter replacement is due. Further, when the air filter is installed, it may be detected whether its unique and genuine.

In an embodiment of the present disclosure, the one or more communication platforms 110 use the one or more sensors 102 to receive the usage data automatically via the one or more communication technologies. The one or more sensors 102 are component sensors installed within the utility equipment. The usage data is telemetry that is coming from the component sensors directly, such as temperature, humidity, pressure and the like. In an exemplary embodiment of the present disclosure, the one or more communication technologies may include cellular, Wireless Fidelity (Wi-Fi) gateway, LoraWAN and the like. If the gateway is not connected to a component, the usage data comes from mobile phone (entered manually or scanning a QR Code) or reading BLE sensors automatically. In an exemplary embodiment of the present disclosure, the one or more sensors 102 include water pressure sensors, temperature sensors and the like. For example, the water pressure sensors may communicate via Bluetooth with the gateway or the mobile phone directly. The gateway is also connected via MODBUS/CANBUS/Serial port to the controller of the component. In an embodiment of the present disclosure, the one or more sensors on the utility equipment send the usage data of the utility equipment, such as temperature, humidity, odometer, fuel used and the like, from the asset or the utility equipment as another payload to the storage unit 206. Further, the data obtaining module 212 obtains the one or more utility parameters associated with the utility equipment from the storage unit 206 and an external API based on the obtained usage data. In an exemplary embodiment of the present disclosure, the one or more utility parameters include a model of the utility equipment, name of the utility equipment, age of the utility equipment, location of the utility equipment (in case of stationary equipment), temperature, humidity, speed, location, run hours, name of user of the utility equipment, and the like. For example, the temperature, humidity, and the like are obtained from the external API to optimize the asset score. Furthermore, the data obtaining module 212 obtains the one or more events and the timing of the one or more events associated with the utility equipment from the storage unit 206 based on the obtained usage data and the obtained one or more utility parameters. In an exemplary embodiment of the present disclosure, the one or more events include one or more periodic scheduled maintenance events, one or more repair events, one or more accident events, one or more audit events, one or more financial events, one or more routing maintenance events or any combination thereof. In an embodiment of the present disclosure, the one or more events are regular maintenance events such as replaced a tire/filter during planned maintenance or unplanned event. For example, the periodic scheduled maintenance events may include replacing oils, changing filters, recharging batteries, power washing, topping off fluids, rotating tires, or a combination thereof. In an exemplary embodiment of the present disclosure, the repair event may include installation of new tires or brake pads, replacing battery, gaskets, 0-rings, replacing failed components, fixing engine transmission or a combination thereof. In an exemplary embodiment of the present disclosure, the accident event may include earthquake, physical damage, environmental changes, or a combination thereof. For example, the audit event may include air quality check, leak inspection, energy efficiency check, fluid check, or a combination thereof. In an exemplary embodiment of the present disclosure, the financial event may include warranty claims, lease expiration, or a combination thereof. For example, the routine maintenance event may be 30-kilometer mile maintenance, 60-kilometer mile maintenance, or a combination thereof.

The data computation module 214 is configured to generate the weight profile associated with the obtained one or more events and the obtained timing of the one or more events based on the set of weight generation rules, the obtained usage data, the obtained one or more utility parameters, the one or more score parameters and the one or more scheduled event timings. In an embodiment of the present disclosure, the set of weight generation rules are predefined rules which facilitate determination of a weight factor to be assigned to each of the one or more events. Further, the one or more scheduled event timings are predefined timings in which the one or more authenticated components are required to be replaced or maintained. In an embodiment of the present disclosure, the data computation module 214 generates the weight profile associated with the obtained one or more events and the obtained timing of the one or more events of the utility equipment upon determination of the model of the utility equipment from the one or more utility parameters. In an exemplary embodiment of the present disclosure, the one or more score parameters include telemetry of the utility equipment, ambient conditions, operator's handling skill or performance, timely maintenance of the utility equipment from the authorized certified personnel or a combination thereof. For example, the ambient conditions may include dusty or clean environment, and weather conditions such as temperature, humidity and the like. In an exemplary embodiment of the present disclosure, the operator's handling skill may include handling shock, handling vibration, handling improper starting and the like. For example, timing of the one or more events may include replacing an air filter in 2 months contains more higher weight factor than 6 months replacement. In generating the weight profile associated with the obtained one or more events and the obtained timing of the one or more events based on the set of weight generation rules, the obtained usage data, the obtained one or more utility parameters, the one or more score parameters and the one or more scheduled event timings, the data computation module 214 determines the weight factor associated with each of the obtained one or more events based on the obtained timing of the one or more events, the set of weight generation rules, the obtained usage data, the obtained one or more utility parameters, the one or more score parameters, and the one or more scheduled event timings. The data computation module 214 also considers historical data determined by experts, an anecdotal experience corresponding to the one or more events or a combination thereof to determine the weight factor. In an embodiment of the present disclosure, the anecdotal experience are user-defined rules that are configurable in the computing system 104 for a given model of the equipment. The anecdotal experience, and the historical data are input to the computing system 104. The historical data is related to asset in a given region. For example, a boiler is shut-down every weekend to save on energy and hence the downtime is ignored. In another example, when the boiler is located in a hospital and is optimized for reliability instead of cost, the parameters are differently configured. Further, the data computation module 214 generates the weight profile by assigning the determined weight factor to each of the obtained one or more events. In an embodiment of the present disclosure, the weight profile is generated based on assignment of the weight factor associated with the one or more events corresponding to the model of the utility equipment. Further, the weight profile corresponds to the set of weight generation rules and the weight factor associated with each of the obtained one or more events for a given model of the utility equipment. Further, the weight profile is created by the anecdotal experience or the historical data. In an embodiment of the present disclosure, a suggested weight profile may also be generated by the computing system 104 based on the historical data as a starting point. The reduces manual work as the suggested weight profile is automatically generated using scripts. In an embodiment of the present disclosure, the weight factor is a multiplier factor on occurrence of the one or more events. The weight factor is determined by an original equipment manufacturer (OEM) based on the historical data, the anecdotal experience corresponding to the one or more events or a combination thereof. In an embodiment of the present disclosure, the weight factor of each event is determined for the given model or class of the utility equipment. In an embodiment of the present disclosure, whenever any event is triggered, such as authorized oil change, the event is matched with timing of the event, whether it was done before the scheduled time or after the scheduled time, such as 3 months. Further, the timing of the event changes the weight and hence the overall asset scare. The example of one weight profile is shown in tabular format below.

| One or More Events | Weight Factor |
|---|---|
| Authorized Oil Change | 0.6 |
| Air Filter Change | 0.8 |
| Oil Filter Change | 0.6 |
| Replaced Lubricating Oil | 0.2 |
| Power Wash | 0.4 |
| Authorized Service | 0.4 |
| Repaired Valves Onsite | 0.3 |
| Registration | 0.4 |
| Replaced Gasket | 0.2 |
| Replaced Springs | 0.2 |
| Replaced Bearings | 0.1 |
| Desiccant Dryers Changed | 0.2 |
| Replaced Seals | 0.2 |
| Replaced Connecting Rods | 0.3 |
| Actuator Check within 3 Months | 0.5 |
| Actuator Check after 3 Months | 0.4 |
| Replaced Bushings | 0.1 |
| Unknown Event | 0.2 |
| Pipeline Change | 0.2 |
| Valve Change | 0.1 |

In an embodiment of the present disclosure, weight factors are calculated for a particular model of the utility equipment by using a dataset. The dataset includes the historical data, occurrence of event as predictors, usage data as predictors, the weather data as predictors and warranty change by model manufactured as predicted value. In an embodiment of the present disclosure, the weight factors corresponding to the predictor may be calculated for the model of the utility equipment by using the dataset. Further, the weight factors may be saved in a configuration file for future use.

Further, the data computation module 214 generates the asset score associated with the utility equipment based on the obtained usage data, the ambient conditions, the obtained one or more utility parameters, the weight profile, and the one or more score parameters. In an embodiment of the present disclosure, the asset score may include a numerical expression for analyzing the one or more events of the utility equipment. In an embodiment of the present disclosure, the asset score corresponds status of the utility equipment, such as well maintained, average maintained, poorly maintained, and the like based on the usage and runtime of the equipment. In an embodiment of the present disclosure, the asset score signifies the operational status of the utility equipment and a score between [0-100] represents how good or bad the utility equipment is maintained over its lifetime.

The data prediction module 216 is configured to predict the rate of variation of the asset score associated with the timings of the one or more events of the utility equipment based on the plurality of historical asset scores, the one or more new events, the generated weight profile, and the generated asset score by using the variation prediction-based AI model. In an exemplary embodiment of the present disclosure, the rate of variation includes an incremental rate, a decremental rate of the asset score or a combination thereof. In an embodiment of the present disclosure, the variation prediction-based AI model is a forecasting model that predicts the future values based on past performance. For example, the variation prediction-based AI model may be a statistical model like Autoregressive Integrated Moving Average (ARIMA), complex neural network algorithms like Convolutional Neural Network-Quantile Regression (CNN-QR), DeepAR+, Prophet, Non-Parametric Time Series (NPTS), Autoregressive Integrated Moving Average (ARIMA), Exponential Smoothing (ETS) and the like. In an embodiment of the present disclosure, CNN-QR is a proprietary machine learning technique for forecasting time series using causal CNNs. CNN-QR works best with large datasets containing hundreds of time series. It accepts item metadata and is the only forecast technique that accepts related time series data without future values. Further, the DeepAR+ is a proprietary machine learning technique for forecasting time series using recurrent neural networks (RNNs). DeepAR+ works best with large datasets containing hundreds of feature time series. The DeepAR+ accepts forward-looking related time series and item metadata. Furthermore, the Prophet is a time series forecasting technique based on an additive model where non-linear trends are fit with yearly, weekly, and daily seasonality. It works best with time series with strong seasonal effects and several seasons of historical data. The NPTS proprietary technique is a scalable, probabilistic baseline forecaster. NPTS is especially useful when working with sparse or intermittent time series. Forecast provides four algorithm variants: standard NPTS, seasonal NPTS, climatological forecaster, and seasonal climatological. Further, ARIMA is a commonly used statistical technique for time-series forecasting. ARIMA is especially useful for simple datasets with under 100 time series. Furthermore, ETS is a commonly used statistical technique for time-series forecasting. The ETS is especially useful for simple datasets with under 100 time series, and datasets with seasonality patterns. ETS computes a weighted average over all observations in the time series dataset as its prediction, with exponentially decreasing weights over time. In an embodiment of the present disclosure, the variation prediction-based AI model may include a machine learning technique to predict the rate of variation of the asset score from the one or more new events received in the real time. In an embodiment of the present disclosure, the rate of variation includes an incremental rate or a decremental rate of the asset score. In an embodiment of the present disclosure, events, their weights, and credits are assigned by hand and not randomized.

Further, in predicting the rate of variation of the asset score associated with the timings of the one or more events of the utility equipment based on the plurality of historical asset scores, one or more new events, the generated weight profile, and the generated asset score by using the variation prediction-based AI model, the data prediction module 216 normalizes the generated asset score for the model of the utility equipment in predefined periodic intervals based on the obtained usage data, the ambient conditions, the obtained one or more utility parameters and the one or more score parameters by using one or more normalization techniques. In an exemplary embodiment of the present disclosure, the softmax function is used as the normalization technique. In an embodiment of the present disclosure, the normalization of the weight factor helps in converting numerical values into a new range by a mathematical function. In an exemplary embodiment of the present disclosure, the one or more normalization techniques include SoftMax technique, a min-max normalization technique, Euclidean, a Z-score technique, a Box-Cox transformation technique or a combination thereof. Further, the data prediction module 216 generates a delta score based on the normalized asset score, the one or more new events, the generated weight profile, a Boolean vector corresponding to occurrence of the one or more new events, a weight vector corresponding to the one or more new events and a weight of usage in the generated asset score. The delta score represents change in the asset score. In an embodiment of the present disclosure, the asset score of a particular component changes when any event occurs, when climatic conditions change, with usage over the time (like every week or every month, which could be considered a scheduled change) and the like. The usage over the time may contribute to decreasing the asset score if all other things are kept static i.e., should have a negative correlation with asset score. The data prediction module 216 generates the new cumulative asset score based on the normalized asset score and the generated delta score. Furthermore, the data prediction module 216 normalizes the generated new cumulative asset score by using the one or more normalization techniques. In an embodiment of the present disclosure, the normalized new cumulative asset score is a number between 1 and 100. The data prediction module 216 predicts the rate of variation of the asset score associated with the timings of the one or more events of the utility equipment based on the plurality of historical asset scores, the normalized new cumulative asset score and the one or more events by using the variation prediction-based AI model. In an embodiment of the present disclosure, the asset score is normalized across similar equipment models of the same type, and the rate of variation of the asset score is predicted. Further, based on how fast it increases or decreases, the incentive is calculated. The health condition determination module 217 is configured to determine the health condition of the utility equipment based on the generated weight profile, the generated asset score, and the predicted rate of variation by using a health condition-based AI model. In an embodiment of the present disclosure, the health condition of the utility equipment is good performance, average performance, low performance, overheated, low risk, or high risk. For example, when the health condition of the utility equipment is low risk or high risk, the user is required to get the utility equipment replaced or maintained.

The data incentive module 218 is configured to update the one or more dynamic incentives associated with the one or more authenticated components, the one or more authenticated services or a combination thereof dynamically based on the predicted rate of variation of the asset score and the set of dynamic incentive rules. In an embodiment of the present disclosure, the one or more incentives dynamically changes at every interval based on the predicted rate of variation of the asset score, and the set of dynamic incentive rules. In an exemplary embodiment of the present disclosure, the one or more dynamic incentives include a warranty period and one or more terms and conditions in a warranty document, a rebate, a discount, a coupon, a virtual cash, a redeem point, a price training, a resale value, or a combination thereof. For example, updating the one or more dynamic incentive include dynamically increasing the warranty period based on the incremental rate of the asset score, dynamically decreasing the warranty period based on the decremental rate of the asset score, adjusting the type of the warranty, such as powertrain or bumper to bumper, adjusting the one or more terms and conditions in the warranty document, such as extending the warranty of the parts or including labor charges, providing the one or more dynamic incentives to the one or more users, and the like. In an embodiment of the present disclosure, incentives are calculated at every predefined time period, such as 3 months, 6 months, 12 months, and the like. The incentives are dynamic and change at every interval based on the asset score. The data incentive module 218 also calculates credits for each event that shows the user that good behavior is rewarded, and bad behavior decreases the incentive value. In updating the one or more dynamic incentives associated with the one or more authenticated components, the one or more authenticated services, or a combination thereof dynamically based on the predicted rate of variation of the asset score and the set of dynamic incentive rules, the data incentive module generates one or more credits based on the generated weight profile and the generated asset score. Further, the data incentive module updates the one or more dynamic incentives associated with the one or more authenticated components, the one or more authenticated services, or a combination thereof dynamically based on the predicted rate of variation of the asset score, the set of dynamic incentive rules, and the generated one or more credits. For example, if the filter is supposed to be replaced in every 3 months, and if the filter is not installed at all, a negative credit is provided. When the genuine filter is installed at 3 months, a +10 credit is provided based on the weight profile. When the non-genuine filter is installed at 3 months, +3 credit is provided based on the weight profile. If the genuine filter is installed at 5th month, then +5 credit is calculated. Example table of incentive profile from the manufacturer (not limited to) is as follows:

| Asset Score | | |
|---|---|---|
| Rate of Change | Incentive | Dynamic Value (Example) |
| 5% | Warranty Period | Extended by 1 week (or 1 year) |
| 6% | Warranty Type | Silver Plan to Platinum Plan |
| 10% | Distributor Rebate | $1000 at the end of year |
| 12% | Coupon | Free Oil Service or Free |
| | | Installation |
| 30% | Discount Coupon | 20% off for next service |
| 40% | Discount Coupon | 10% of new vehicle purchase |

In an embodiment of the present disclosure, the one or more users may receive notification of one or more dynamic incentives via the monitor login or one or more electronic devices 108. In an exemplary embodiment of the present disclosure, the one or more terms and conditions may include a warranty type, a warranty scope, a warranty risk, a warranty reward, or a combination thereof. In an embodiment of the present disclosure, adjusting the one or more terms and conditions include adjusting the warranty type, the warranty scope, the warranty risk, the warranty reward, or a combination thereof. In an embodiment, the warranty period is a duration until which the manufacturer is liable for any parts and labor charges, when the machine fails. In such embodiment, the warranty period value can be extended by any time duration, such as an hour, a day, a week, a month, a quarter, or a combination thereof. In one embodiment, if the dynamic warranty is decreased for a customer, then the one or more terms and conditions such as the warranty type, the warranty length, the warranty scope, and the like are decreased based on a consent of the customer. In such a scenario, the customer is offered one or more inducements in higher multiples such as the warranty period increases by two times. In an embodiment of the present disclosure, the warranty length may be increased or decreased depending on the change in the normalized asset score. The change is dependent on the magnitude of rate of change of normalized asset score with respect to time.

The notification generation module 220 is configured to generate the one or more notifications corresponding to the updated one or more dynamic incentives.

The data output module 222 is configured to output the generated one or more notifications, the predicted rate of variation and the determined health condition on user interface screen of the one or more electronic devices 108 associated with the one or more users via the one or more communication channels. In an exemplary embodiment of the present disclosure, the one or more communication channels include a Short Message Service (SMS), a multimedia message, a push notification on mobile phone, an email, and the like. In an embodiment of the present disclosure, the predicted rate of variation is outputted in one or more visualization formats. The one or more visualization formats include charts, graphs, or a combination thereof. In another embodiment of the present disclosure, the one or more notifications of adjustment of the dynamic warranty for the model of the utility equipment may be sent via a user login onto the platform. The user may login onto the platform via a monitor.

Further, the data computation module 214 is configured to generate one or more dynamic factors associated with the model of the utility equipment, based on the obtained usage data, the obtained one or more utility parameters, the weight profile, the asset score and the one or more score parameters. In an embodiment of the present disclosure, the one or more dynamic factors include a dynamic calculation of resale value, a dynamic dispatch of technician with the right skill set, a dynamic parts inventory of which parts to stock and which parts not stock, a dynamic technician pricing as the lower asset score demands more work from a highly skilled technician, a dynamic training so the asset score can be improved with the right training and reduce mishandling, a dynamic parts pricing of which parts are going to be more popular than others, dynamic repair recommendations as lower asset score for certain class of utility equipment might trigger faster repair recommendation or a combination thereof. In an embodiment of the present disclosure, the customer may visualize the dynamic score and the weight profile of the model of the utility equipment from a digital platform. In such embodiment, the digital platform may include a website published on a web server to depict information about the model of the utility equipment, the asset score, various weight profiles and the like. Further, the data computation module 214 generates a dynamic resale value based on the generated one or more dynamic parameters, the asset score, a prior purchase price of the utility equipment and a quality of maintenance of the utility equipment. In an embodiment of the present disclosure, the dynamic resale value may be better if the one or more genuine parts are used at a right time, which in turn maintains the quality. Further, the asset score may be less if the one or more parts used in the utility equipment are not genuine which in turn degrades the quality of maintenance of the utility equipment. Furthermore, the dynamic resale value of the utility equipment may be determined for a second owner and a third owner based on the prior purchase price of the utility equipment. The data computation module 214 determines an age of the utility equipment based on the generated one or more dynamic parameters, the asset score, and the quality of maintenance of the utility equipment. In an embodiment of the present disclosure, the dynamic score provides data in case of legacy equipment. Based on the determined age and algorithmic data, a certified technician having the right skills may be dispatched to replace one or more defected parts with the one or more authorized parts. Further, the asset score is also used to determine the technician's rate dynamically and cost of the overall replacement with guarantee.

Further, the data computation module 214 determines a certified technician having required technical skills to replace one or more defected components with one or more authorized components based on the determined age, and the asset score. In an embodiment of the present disclosure, the asset score, the weight profile and the frequency of replacement of parts helps in determining the operator's work to operate the equipment. The data computation module 214 determines service charge of the certified technician and cost of replacement with guarantee based on the determined certified technician, the asset score, the weight profile and a frequency of replacement of the one or more defected components. The data computation module generates one or more operator recommendations based on the determined certified technician, the asset score, the weight profile and the frequency of replacement of the one or more defected components. For example, if the operator has changed the filter 5 times more than needed, then a specific type of training personalized to the customer and the operator may be provided. Furthermore, the data computation module 214 determines a dynamic part inventory and a dynamic part pricing based on the generated one or more dynamic parameters, the asset score, an exact quantity of inventory required by an Original Equipment Manufacturer (OEM) to keep in hands and an exact quantity of inventory required by an inventory distributor to keep in a warehouse. In an embodiment of the present disclosure, Just-in-time inventory may be created, such that no understock or overstock of an item takes place. Since maintenance events and parts usage data is received continuously, the right inventory may be accurately predicted based on the sensor values and asset score. In an embodiment of the present disclosure, an understocking, and an overstocking of the inventory for OEM and inventory distributors may be removed by determining the exact quantity of the inventory required in both cases. In an embodiment of the present disclosure, the dynamic part pricing is based on popularity of the component or lack of it. If a particular component is running low on inventory, then based on the asset score, the price increase of that component is suggested. The price of the part is adjusted automatically based on its frequency of changes across different models. The data computation module 214 determines one or more components required to ship overnight, keep in stock or a combination thereof based on the asset score and the one or more dynamic parameters.

The notification generation module 220 determines if replacement or maintenance of the one or more authenticated components is required based on the one or more scheduled event timings, the obtained usage data, the obtained one or more utility parameters, the generated weight profile, a standard lifetime of the one or more authenticated components, the determined health condition, and the one or more score parameters. Further, the notification generation module 220 generates one or more notifications to replace the one or more authenticated components upon determining that the one or more authenticated components are required to be replaced. The generated one or more notifications are outputted on user interface screen of the one or more electronic devices 108 associated with the one or more users via the one or more communication channels or the one or more authenticated components. The notification generation module 220 generates one or more recommendations to schedule maintenance of the one or more authenticated components upon determining that the one or more authenticated components are required to be maintained. The generated one or more recommendations are outputted on user interface screen of the one or more electronic devices 108 associated with the one or more users and one or more technician devices associated with one or more technicians via the one or more communication channels. In an embodiment of the present disclosure, alerts are sent to the one or more users for notifying a replacement of the one or more authenticated components in the utility equipment based on a pre-defined requirement. In one embodiment, the alert for the replacement may be sent based on a standard lifetime of the one or more authenticated components. Further, the scheduled maintenance event of the one or more authenticated components may be performed after a pre-defined interval of time. In another embodiment of the present disclosure, a conditional maintenance of the one or more authenticated components may depend upon the condition of the one or more authenticated components. In an embodiment of the present disclosure, the alert for the replacement of the one or more authenticated components may be sent by the one or more authenticated components itself.

The compliance monitoring module 224 determines if one or more authenticated components are required to be installed on the utility equipment based on the obtained usage data, the obtained one or more utility parameters, the generated weight profile, the one or more score parameters, and a predefined component information. Further, the compliance monitoring module 224 determines if the installed one or more authenticated components are one or more required authenticated components based on the predefined component information. The compliance monitoring module 224 generates one or more notifications to replace the installed one or more authenticated components with the one or more required components upon determining that the installed one or more authenticated components are not the one or more required authenticated components. In an embodiment of the present disclosure, the generated one or more notifications are outputted on user interface screen of the one or more electronic devices 108 associated with the one or more users via the one or more communication channels. In an embodiment of the present disclosure, it is checked whether the one or more authenticated components are supposed to be installed on the utility equipment or not. For example, if “Filter XT” is only recommended for the utility equipment XY, and if installed, then the weight profile and the asset score is higher and if “Filter XS” is installed by mistake, then the weight profile is lower and sends an alert to the one or more users. However, the utility equipment still operates fine as both filters are still authenticated and genuine parts.

In an embodiment of the present disclosure, the authenticity determination module 226 receives a data representative of the one or more authenticated components and status of the one or more authenticated components in form of a transaction from one or more contacts via a decentralized ledger. In an embodiment of the present disclosure, the one or more contacts correspond to network nodes of a blockchain. In an embodiment of the present disclosure, the Blockchain is used to determine the authenticity of the authenticated part. The Blockchain is used as tamper-proof, append-only database and distributed nodes to verify that a component is indeed genuine. Further, the authenticity determination module 226 verifies the transaction upon receiving approval from the network nodes through a consensus mechanism. The verified transaction represents that the one or more authenticated components are authentic. Furthermore, the authenticity determination module 226 adds the verified transaction to the blockchain upon verifying the transaction. For example, the one or more contacts, such as supplier, OEM, distributor, and the owner/operator all interact with a component at various points from manufacturing the component, tagging the component, shipping, installation and so on. Each party uses the decentralized ledger to send the data about an asset it is installed on, timestamp and hash keys that ensures it is unique and can be installed only once. Further, each party sends data about the component and its status in a transaction. Furthermore, each transaction is verified by network nodes through a consensus mechanism before being added to the blockchain.

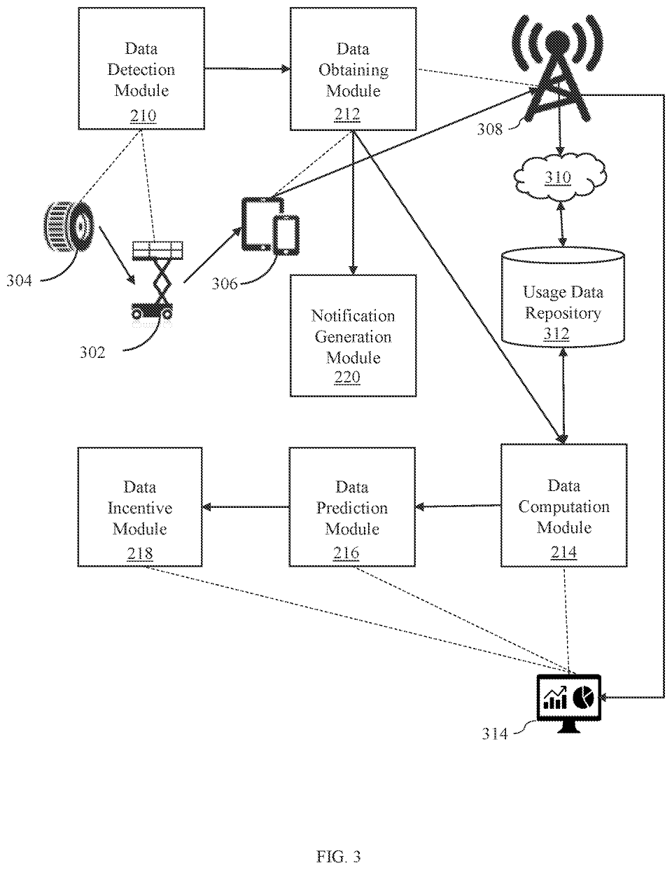

FIG. 3 is schematic representation of an exemplary embodiment of the computing system 104 to facilitate management of the utility equipment, in accordance with an embodiment of the present disclosure. The computing system 104 provides the one or more dynamic incentives to customers who purchase original equipment (OE) and one or more authenticated or genuine components from the OEM of any industry. Considering an example, where the OEM ‘A’ manufactures commercial vehicles such as trucks 302. The OEM ‘A’ offers standard fixed-term warranty for new truck sales and such warranties typically last between a definite period of time such as about 3 years. During this warranty period, in case of any damage or replacement, customers are purchasing the one or more authenticated components from the OEM. However, after the expiration of the warranty period, the customers are avoiding purchase of the one or more authenticated components from the OEM ‘A’ in order to reduce their operational costs. As a result, the OEM ‘A’ is losing after-market sales for the remaining lifetime of the truck sold. In order to manage the after-market sales of the OEM ‘A’, the computing system 104 is utilized which enables the OEM ‘A’ to offer dynamic incentive programs to the customers.

The computing system 104 monitors in real-time, the usage of the one or more authenticated components, such as a tire 304 of the utility equipment such as the trucks 302. For real-time monitoring, detection of the one or more authenticated components is essential. The data detection module 210 enables detection of the one or more authenticated components for uniqueness by scanning the unique encrypted code associated with the one or more authenticated components of the utility equipment using a wireless detection means such as Bluetooth® tag. In an example used herein, the wireless detection means may include a software application which scans the unique encrypted code associated with the one or more authenticated components. Here, the software application may be installed in the electronic device such as a tablet 306 or mobile phone. Once the unique encrypted code is scanned, the code is matched with a list including multiple codes which is stored in the component data repository in the cloud for uniqueness and compliance. If the scanned code matches with the list of the multiple bar codes for the authenticated equipment, then usage of the at least one authenticated or genuine component is identified by the data detection module 210. The usage identified with the one or more authenticated components helps in understanding warranty status such as either active status or inactive status. Upon identification of usage, the data obtaining module 212 obtains the usage data of the one or more authenticated component via a gateway 308 for transmission of the usage data to a cloud-based platform 310. The gateway 308 collects the usage data of the one or more authenticated components from a user and equipment data of equipment in which the component was installed and transmits to the cloud-based platform 310. The cloud-based platform 310 also includes the usage data repository 312 which stores the usage data collected via the gateway 308.

Further, in the cloud-based platform 310, upon transmission of the usage data, multiple details such as a model of the utility equipment, name of the utility equipment, name of an owner of the utility equipment, multiple warranty details including warranty status, warranty type, warranty coverage and the like are fetched. For example, the model of the equipment may include ‘S-45’, the name of the utility equipment as ‘heavy duty truck’ the owner's name as ‘X’, the warranty status as ‘active’, the warranty type as ‘standard 3-year warranty’, the warranty coverage as ‘power train and one or more components’. Such information is later utilized by the data computation module 214 for generating the weight profile. The weight profile is created by the data computation 214 in association with multiple events of the utility equipment. For example, the multiple events may include periodic scheduled maintenance, usage of a genuine part, usage of genuine filter, usage of genuine lubricants, installation of new tires 304, air quality check and the like. For each of these multiple events, a corresponding weight factor is assigned for creation of the weight profile. The weight factor is determined by the OEM based on the historical data corresponding to the multiple events, anecdotal experience corresponding to the multiple events or a combination thereof. The data computation module 214 also normalizes the weight factor by using the one or more normalization techniques for generation of the asset score associated with the model of the utility equipment. In the example used herein, a min-max normalization technique may be used for normalization of the weight factor.

Once, creation of the weight profile is completed, the asset score associated with the timing of events of the model of the utility equipment is generated via mathematical computation based on multiple parameters. For example, the multiple parameters may include at least one of performance of the utility equipment, usage data of the at least one authenticated component, ambient conditions and weather conditions, an operator's skill or performance, the plurality of events or a combination thereof. The asset score includes a numerical expression for analyzing the multiple events of the utility equipment. Let us assume, that the asset score for the truck is generated as ‘60’, then such asset score is checked for a predefined interval of time. The data prediction module 216 predicts the rate of variation of the asset score associated with the timing of events of the model of the utility equipment. For example, the rate of variation may include an incremental rate or a decremental rate. The data prediction module 216 analyses one or more factors for prediction of the rate of the variation of the asset score. Also, predicted result generated by the data prediction module 216 is depicted in one or more visualization formats 314 such as charts, graphs and the like for the customer. Again, the data incentive module 218 adjusts a warranty period and one or more terms and conditions in a warranty document dynamically based on the rate of variation of the asset score predicted. For example, if the rate of variation of the asset score is predicted as increasing, then the warranty adjustment subsystem increases the warranty period. In one non-limiting example, the warranty period, which is extended dynamically, may include an extension of duration of 6 months or 6 days. Also, the one or more terms and conditions in the warranty document changes to benefit the owner of the equipment.

Furthermore, the computing system 104 includes the data output module 222 which sends an alert to the customer for notifying a replacement of the one or more authenticated components in the utility equipment based on the predefined requirement. For example, the alert for the replacement may be sent based on a standard lifetime of the one or more authenticated components. For example, the alert may be sent to the customer via a text message. Further, the data incentive module 218 also provides the one or more dynamic incentives to the customer based on the asset score generated. The one or more dynamic incentives motivate the customer or owner of the utility equipment to maintain properly and as a result gets benefitted in terms of receiving dynamic warranty programs as a loyal customer. In addition to, by offering the dynamic warranty programs to the customer, the OEMs also gets benefitted in overcoming the after sales revenue successfully.

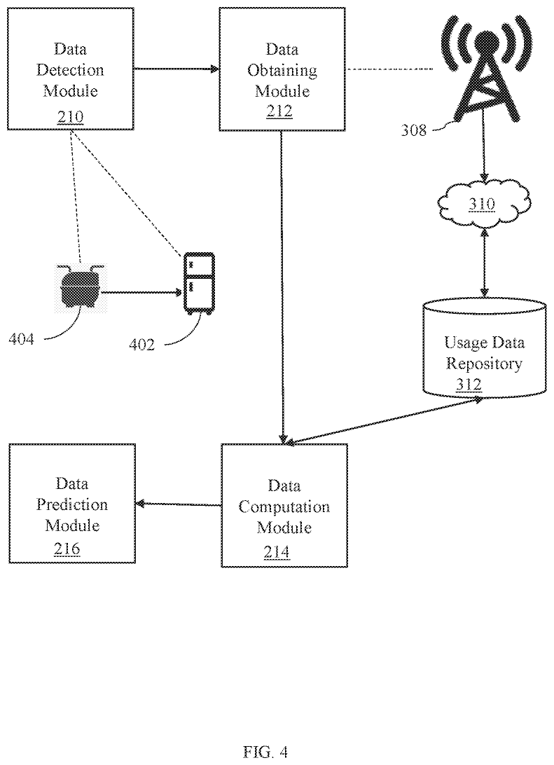

FIG. 4 is schematic representation of an exemplary embodiment of the computing system 104 to facilitate management of the utility equipment, in accordance with another embodiment of the present disclosure. The computing system 104 provides dynamic warranty to customers who purchase OE and one or more authenticated or genuine components from the OEM of any industry. Considering an example, where the OEM ‘A’ manufactures industrial equipment such as refrigerators 402. The OEM ‘A’ offers standard fixed-term warranty for new refrigerator sales and such warranties typically last between a definite period of time such as about 3 years. Further, the computing system 104 monitors in real-time, the usage of the one or more authenticated components, such as a compressor 404 of the industrial utility equipment such as the refrigerator 402. The data detection module 210 enables detection of the one or more authenticated components for uniqueness by scanning a unique encrypted code associated with the one or more authenticated components of the utility equipment by using the wireless detection means such as Bluetooth tag. Upon identification of usage, the data obtaining module 212 obtains the usage data the one or more authenticated components via a gateway 308 or mobile phone or tablet 306 for transmission of the usage data to the cloud-based platform 310. The cloud-based platform 310 also includes a usage data repository 312 which stores the usage data collected via the gateway 308 or mobile phone.

Further, in the cloud-based platform 310, upon transmission of the usage data, multiple details such as a model of the industrial utility equipment, name of the industrial utility equipment, name of an owner of the industrial utility equipment, multiple warranty details including warranty status, warranty type, warranty coverage and the like are fetched. For example, the model of the industrial utility equipment such as the refrigerator 402 may include ‘L-195’, the owner's name as ‘P’, the warranty status as ‘active’, the warranty type as ‘3-year warranty’, the warranty coverage as ‘compressor and one or more components’. Such information is later utilized by the data computation module 214 for creation of a weight profile in association with multiple events of the industrial utility equipment. For example, the multiple events may include periodic scheduled maintenance, usage of a genuine part, usage of genuine condenser, installation of new compressor, air quality check and the like. Once, creation of the weight profile is completed, the asset score associated with the timing of events of the model of the utility equipment is generated via mathematical computation based on multiple parameters. Let us assume, that the asset score for the refrigerator 402 is generated as ‘70’, then such asset score is checked for a pre-defined interval of time. The data prediction module 216 predicts a rate of variation of the asset score associated with the timing of events of the model of the utility equipment. For example, the rate of variation may include an incremental rate or a decremental rate.

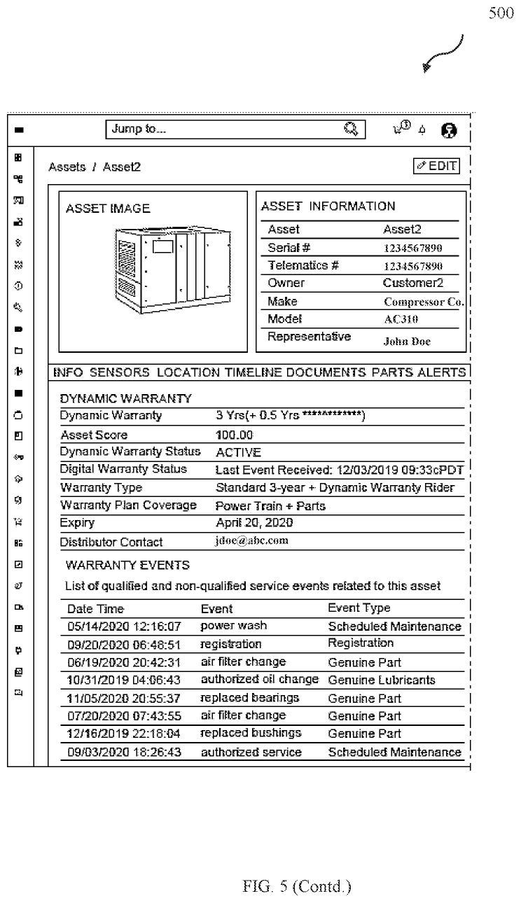

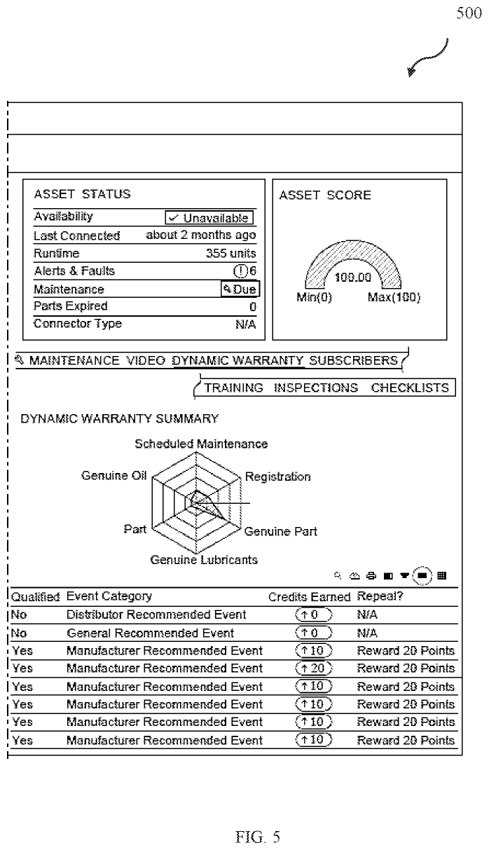

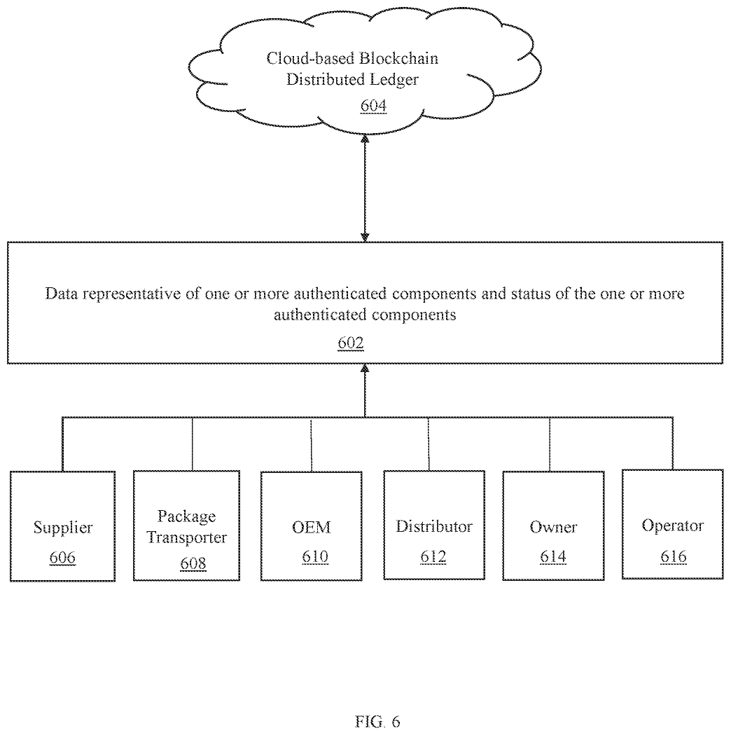

FIG. 5 is graphical user interface screen 500 of the exemplary computing system 104 to provide data-driven dynamic recommendations for equipment maintenance lifecycle, in accordance with an embodiment of the present disclosure. The graphical user interface screen 500 shows asset image, asset information, dynamic warranty, and the like. In the current scenario, the warranty is extended by 1 year in the digital dynamic warranty portion because it is a perfect asset score of 100. Further, multiple weights factors are calculated based on the weight profile of this asset model and converted into credits earned. The current example shows maintenance events. However, the same may be done based on sensor usage data and weather/environment data as well. Furthermore, sensors data, components usage data, the weather data, the maintenance events, the weather/environment data and the like may also be considered to calculate the asset score.

FIG. 6 is a block diagram illustrating an exemplary process for adding a verified transaction to a blockchain, in accordance with an embodiment of the present disclosure. In an embodiment of the present disclosure, the data representative of the one or more authenticated components and the status of the one or more authenticated components 602 is received in form of the transaction from the one or more contacts via the decentralized ledger. In an embodiment of the present disclosure, the ledger is a cloud-based blockchain distributed ledger 604. For example, the data representative of the one or more authenticated components includes part serial, part, tag, timestamps, and the like. For example, the status of the one or more authenticated components includes under warranty, warranty expired and the like. In an embodiment of the present disclosure, the one or more contacts correspond to network nodes of the blockchain. The network nodes include supplier 606, package transporter 608, OEM 610, distributor 612, owner 614, operator 616 and the like. Further, the transaction is verified upon receiving approval from the network nodes through a consensus mechanism. For example, in the current scenario, part 1234 installed on asset 1 is verified by 10 nodes. Furthermore, the verified transaction is added to the cloud-based blockchain distributed ledger 604 upon verifying the transaction.

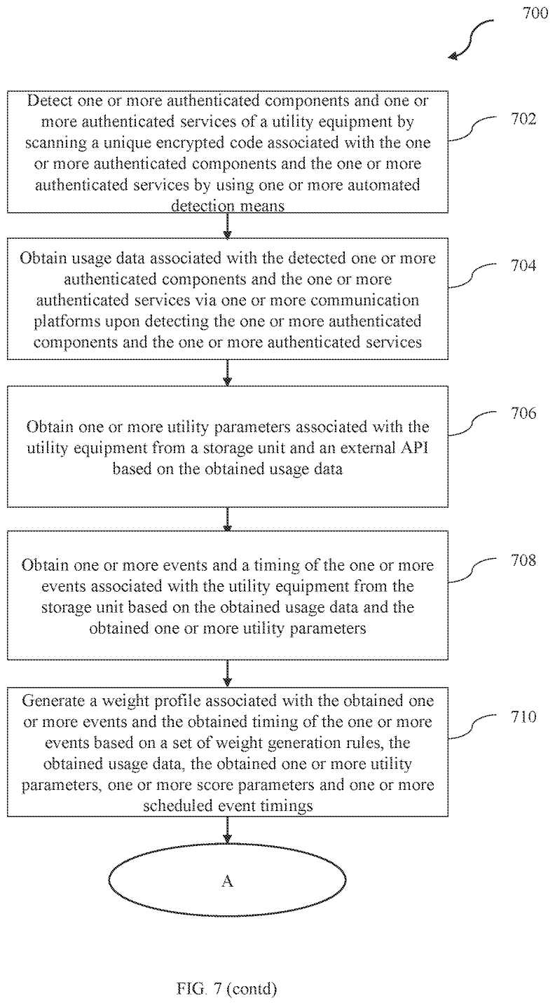

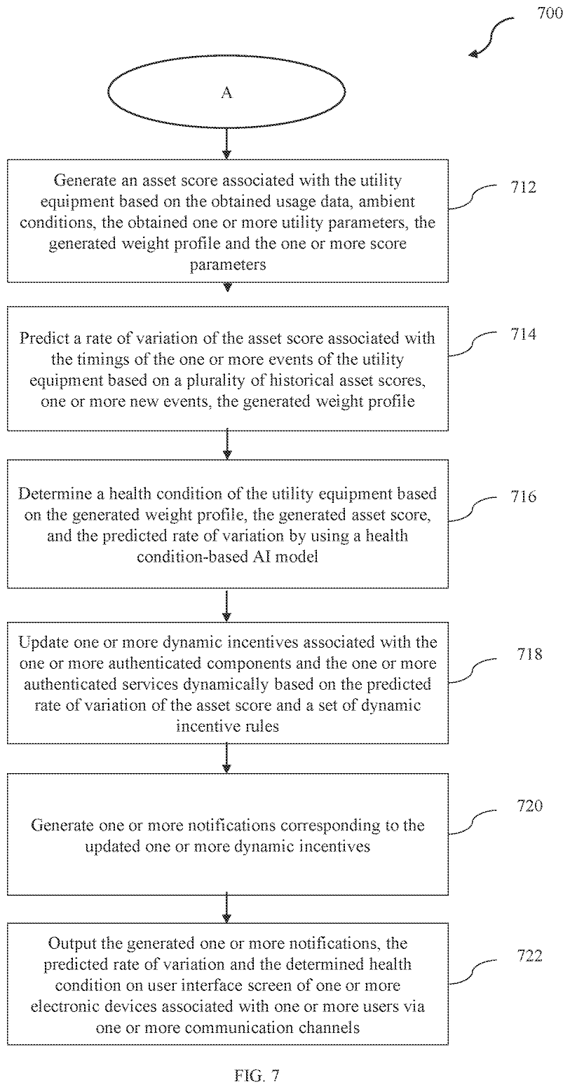

FIG. 7 is a process flow diagram illustrating an exemplary method 800 to provide data-driven dynamic recommendations for equipment maintenance lifecycle, in accordance with an embodiment of the present disclosure. At step 702, one or more authenticated components, one or more authenticated services or a combination thereof of a utility equipment are detected for uniqueness and compliance by scanning a unique encrypted code associated with each of the one or more authenticated components, the one or more authenticated services or a combination thereof by using one or more automated detection means. In an embodiment of the present disclosure, counterfeiting of the one or more authenticated components, the one or more authenticated services or a combination thereof may also be identified based on the detection of the one or more authenticated components, the one or more authenticated services or a combination thereof. For example, the one or more authenticated components include an industrial equipment, a component of a commercial equipment, a component of a consumer utility equipment or a combination thereof. For example, the one or more authenticated components may also include filters, lubricants, spare parts, engine, compressor, motors, pumps, blades, brakes, battery, and the like. In an exemplary embodiment of the present disclosure, the utility equipment may include a heavy machine vehicle like trucks, tree-shaker, railway maintenance or construction and material handling portable machines, a consumer electronic product, a portable or stationary industrial machine such as compressors, chillers, and the like. In embodiment of the present disclosure, the one or more authenticated services are maintenance services performed at an authorized and certified technician, distributor, dealer, and the like.

In an embodiment of the present disclosure, the one or more detection means include one or more wired detection means, one or more wireless detection means or a combination thereof. For example, the one or more wired detection means may include 1-Wire protocol device or a bar code scanning device. In an embodiment of the present disclosure, the one or more wireless detection means may include an application of the computing system 104 for reading the unique encrypted code embedded in an NFC tag, a RFID tag or BLE tag, or a wired sensor or touch technology like EEPROM, and the like. In an embodiment of the present disclosure, the unique encrypted code of the one or more authenticated components, the one or more authenticated services or a combination thereof upon scanning is matched with a list of multiple unique encrypted codes associated with multiple authenticated components and multiple authenticated services stored in a component repository and service repository respectively to check the uniqueness of the scanned code. The matching is done to identify usage of the one or more authenticated components, the one or more authenticated services or a combination thereof and ensure that the unique encrypted code can be used only once in its lifetime. In an embodiment of the present disclosure, the usage of the one or more authenticated components, the one or more authenticated services or a combination thereof may be identified based on assets historical data by using the unique encrypted code. In an embodiment of the present disclosure, the assets historical data corresponds to the list of multiple unique encrypted codes in the storage unit 206. In a scenario, when the unique encrypted code is not present in the storage unit 206 or used earlier by anyone, then the one or more authenticated components, the one or more authenticated services or a combination thereof are not genuine. In another embodiment, the usage of the one or more authenticated components, the one or more authenticated services or a combination thereof is identified by using one or more artificial intelligence techniques in an absence of unique encrypted code or disconnection of the asset. In an embodiment of the present disclosure, pattern-matching technology is used to determine various parameters such as model, serial number, age, time, location of the one or more authenticated components, the one or more authenticated services or a combination thereof. For example, when the unique encrypted code or the asset/equipment is absent or lost, and it is detected that the one or more equipments are still running by sensor values, a multi-variate anomaly detection is used to detect anomalies and also use missing values imputation methods to fill missing values. These AI techniques helps are used to intelligently authenticate a part, component or consumable. Further, the term ‘unique encrypted code’ is defined as a unique code associated with a component for representation of data in a visual and machine-readable form. For example, the unique encrypted code includes a bar code, a Quick Response (QR) code, an alphanumeric code, and the like. In an embodiment of the present disclosure, the unique encrypted code is detected by manually scanning the unique encrypted code during installation by using scanners, smart phones, and the like. In an embodiment of the present disclosure, the unique encrypted code is generated and stored in the storage unit 206. In such embodiment, the unique encrypted code is integrated or embedded with the one or more authenticated components, the one or more authenticated services or a combination thereof of the utility equipment.

At step 704, usage data associated with the detected one or more authenticated components, the detected one or more authenticated services or a combination thereof is obtained via one or more communication platforms 110 upon detecting the one or more authenticated components, the one or more authenticated services or a combination thereof. The usage data is obtained for transmission and storage to a cloud-based platform i.e., the storage unit 206. In an embodiment of the present disclosure, the one or more communication platforms 110 may include a gateway or an application platform. In such embodiment, the application platform may include a mobile application. In an embodiment of the present disclosure, the usage data of the one or more authenticated components, the one or more authenticated services or a combination thereof is collected via the one or more communication platforms 110 for transmission of the usage data to the cloud-based platform in real time. The one or more communication platforms 110 collect the usage data of the one or more authenticated components, the one or more authenticated services or a combination thereof by the one or more users and transmits to the cloud-based platform. The cloud-based platform also includes a usage data storage repository which stores the usage data collected via the one or more communication platforms 110. In an exemplary embodiment of the present disclosure, the usage data may include data of usage of the one or more authenticated components in a predefined time period, data of usage of the one or more authenticated services in the predefined time period, data of usage of the utility equipment in a predefined geographical location, data of installation event, data of maintenance service performed, data of usage of the utility equipment based on guidance provided in a handbook or a combination thereof. In an embodiment of the present disclosure, the usage data also includes location i.e., latitude and longitude of the one or more authenticated components, the one or more authenticated services or a combination thereof, time of the event, installation type, and the like which are automatically captured. In an exemplary embodiment of the present disclosure, the installation type may include factory install, replacement, repair, regular maintenance, and the like. Further, the usage data is sent along with the unique encrypted code and timestamp as payload to the storage unit 206. This payload is sent once or twice every day. In an embodiment of the present disclosure, the usage data of the one or more authenticated components may include usage of Bluetooth tags to see if the unique encrypted codes are unique, usage of the Bluetooth tags to see if the unique encrypted codes are compliant, reminders on lifetime and the like. In an embodiment of the present disclosure, the unique encrypted code is embedded inside the tag. In such embodiment, the usage of the Bluetooth tags to see if the unique encrypted codes are unique may include the unique encrypted codes or filters which cannot be reused again, no one can clean the air filter or refill the ink in the old cartridge. In an embodiment of the present disclosure, once the unique encrypted code is transmitted to the storage unit 206 along with the timestamp in the payload, the timestamp is used to know when a component was installed and when it is getting expired based on the lifetime of that component. For example, an air filter is installed on time t1, air filter needs to be replaced every 3 months, an alert may be triggered after 3 months that air filter replacement is due. Further, when the air filter is installed, it may be detected whether its unique and genuine.

In an embodiment of the present disclosure, the one or more communication platforms 110 use the one or more sensors 102 to receive the usage data automatically via the one or more communication technologies. The one or more sensors 102 are component sensors installed within the utility equipment. The usage data is telemetry that is coming from the component sensors directly, such as temperature, humidity, pressure and the like. In an exemplary embodiment of the present disclosure, the one or more communication technologies may include cellular, Wireless Fidelity (Wi-Fi) gateway, LoraWAN and the like. If the gateway is not connected to a component, the usage data comes from mobile phone (entered manually or scanning a QR Code) or reading BLE sensors automatically. In an exemplary embodiment of the present disclosure, the one or more sensors 102 include water pressure sensors, temperature sensors and the like. For example, the water pressure sensors may communicate via Bluetooth with the gateway or the mobile phone directly. The gateway is also connected via MODBUS/CANBUS/Serial port to the controller of the component. In an embodiment of the present disclosure, the one or more sensors on the utility equipment send the usage data of the utility equipment, such as temperature, humidity, odometer, fuel used and the like, from the asset or the utility equipment as another payload to the storage unit 206.

At step 706, one or more utility parameters associated with the utility equipment are obtained from a storage unit 206 and an external API based on the obtained usage data. In an exemplary embodiment of the present disclosure, the one or more utility parameters include a model of the utility equipment, name of the utility equipment, age of the utility equipment, location of the utility equipment (in case of stationary equipment), temperature, humidity, speed, location, run hours, name of user of the utility equipment, and the like. For example, the temperature, humidity, and the like are obtained from the external API to optimize the asset score.

At step 708, one or more events and the timing of the one or more events associated with the utility equipment are obtained from the storage unit 206 based on the obtained usage data and the obtained one or more utility parameters. In an exemplary embodiment of the present disclosure, the one or more events include one or more periodic scheduled maintenance events, one or more repair events, one or more accident events, one or more audit events, one or more financial events, one or more routing maintenance events or any combination thereof. In an embodiment of the present disclosure, the one or more events are regular maintenance events such as replaced a tire/filter during planned maintenance or unplanned event. For example, the periodic scheduled maintenance events may include replacing oils, changing filters, recharging batteries, power washing, topping off fluids, rotating tires, or a combination thereof. In an exemplary embodiment of the present disclosure, the repair event may include installation of new tires or brake pads, replacing battery, gaskets, 0-rings, replacing failed components, fixing engine transmission or a combination thereof. In an exemplary embodiment of the present disclosure, the accident event may include earthquake, physical damage, environmental changes, or a combination thereof. For example, the audit event may include air quality check, leak inspection, energy efficiency check, fluid check, or a combination thereof. In an exemplary embodiment of the present disclosure, the financial event may include warranty claims, lease expiration, or a combination thereof. For example, the routine maintenance event may be 30-kilometer mile maintenance, 60-kilometer mile maintenance, or a combination thereof.

At step 710, a weight profile associated with the obtained one or more events and the obtained timing of the one or more events is generated based on a set of weight generation rules, the obtained usage data, the obtained one or more utility parameters, one or more score parameters and one or more scheduled event timings. In an embodiment of the present disclosure, the set of weight generation rules are predefined rules which facilitate determination of a weight factor to be assigned to each of the one or more events. Further, the one or more scheduled event timings are predefined timings in which the one or more authenticated components are required to be replaced or maintained. In an embodiment of the present disclosure, the weight profile associated with the obtained one or more events and the obtained timing of the one or more events of the utility equipment is generated upon determination of the model of the utility equipment from the one or more utility parameters. In an exemplary embodiment of the present disclosure, the one or more score parameters include telemetry of the utility equipment, ambient conditions, operator's handling skill or performance, timely maintenance of the utility equipment from the authorized certified personnel or a combination thereof. For example, the ambient conditions may include dusty or clean environment, and weather conditions such as temperature, humidity and the like. In an exemplary embodiment of the present disclosure, the operator's handling skill may include handling shock, handling vibration, handling improper starting and the like. For example, timing of the one or more events may include replacing an air filter in 2 months contains more higher weight than 6 months replacement. In generating the weight profile associated with the obtained one or more events and the obtained timing of the one or more events based on the set of weight generation rules, the obtained usage data, the obtained one or more utility parameters, the one or more score parameters and the one or more scheduled event timings, the method 700 includes determining the weight factor associated with each of the obtained one or more events based on the obtained timing of the one or more events, the set of weight generation rules, the obtained usage data, the obtained one or more utility parameters, the one or more score parameters, and the one or more scheduled event timings. The method 700 includes considering historical data determined by experts, an anecdotal experience corresponding to the one or more events or a combination thereof to determine the weight factor. In an embodiment of the present disclosure, the anecdotal experience are user-defined rules that are configurable in the computing system 104 for a given model of the equipment. The anecdotal experience, and the historical data are input to the computing system 104. Further, the method 700 includes generating the weight profile by assigning the determined weight factor to each of the obtained one or more events. In an embodiment of the present disclosure, the weight profile is generated based on assignment of the weight factor associated with the one or more events corresponding to the model of the utility equipment. Further, the weight profile corresponds to the set of weight generation rules and the weight factor associated with each of the obtained one or more events for a given model of the utility equipment. Further, the weight profile is created by the anecdotal experience or the historical data. In an embodiment of the present disclosure, a suggested weight profile may also be generated by the computing system 104 based on the historical data as a starting point. In an embodiment of the present disclosure, the weight factor is a multiplier factor on occurrence of the one or more events. The weight factor is determined by an original equipment manufacturer (OEM) based on the historical data, the anecdotal experience corresponding to the one or more events or a combination thereof. In an embodiment of the present disclosure, the weight factor of each event is determined for the given model or class of the utility equipment. In an embodiment of the present disclosure, whenever any event is triggered, such as authorized oil change, the event is matched with timing of the event, whether it was done before the scheduled time or after the scheduled time, such as 3 months. Further, the timing of the event changes the weight and hence the overall asset score. The example of the weight profile is shown in tabular format below.

| One or More Events | Weight Factor |
|---|---|
| Authorized Oil Change | 0.6 |
| Air Filter Change | 0.8 |
| Oil Filter Change | 0.6 |
| Replaced Lubricating Oil | 0.2 |
| Power Wash | 0.4 |
| Authorized Service | 0.4 |
| Repaired Valves Onsite | 0.3 |
| Registration | 0.4 |
| Replaced Gasket | 0.2 |
| Replaced Springs | 0.2 |
| Replaced Bearings | 0.1 |
| Desiccant Dryers Changed | 0.2 |
| Replaced Seals | 0.2 |
| Replaced Connecting Rods | 0.3 |
| Actuator Check within 3 Months | 0.5 |
| Actuator Check after 3 Months | 0.4 |
| Replaced Bushings | 0.1 |
| Unknown Event | 0.2 |
| Pipeline Change | 0.2 |
| Valve Change | 0.1 |

In an embodiment of the present disclosure, weight factors are calculated for a particular model of the utility equipment by using a dataset. The dataset includes the historical data, occurrence of event as predictors, usage data as predictors, the weather data as predictors and warranty change by model manufactured as predicted value. In an embodiment of the present disclosure, the weight factors corresponding to the predictor may be calculated for the model of the utility equipment by using the dataset. Further, the weight factors may be saved in a configuration file for future use.

At step 712, an asset score associated with the utility equipment is generated based on the obtained usage data, the obtained one or more utility parameters, the generated weight profile, and one or more score parameters. In an embodiment of the present disclosure, the asset score associated with the model of the utility equipment is generated upon creation of the weight profile. In an embodiment of the present disclosure, the asset score may include a numerical expression for analyzing the one or more events of the utility equipment. In an embodiment of the present disclosure, the asset score corresponds status of the utility equipment, such as well maintained, average maintained, poorly maintained, and the like based on the usage and runtime of the equipment. In an embodiment of the present disclosure, the asset score signifies the operational status of the utility equipment and a score between [0-100] represents how good or bad the utility equipment is maintained over its lifetime.

At step 714, a rate of variation of the asset score associated with the timings of the one or more events of the utility equipment is predicted based on the plurality of historical asset scores, the one or more new events, the generated weight profile, and the generated asset score by using the variation prediction-based AI model. In an exemplary embodiment of the present disclosure, the rate of variation includes an incremental rate, a decremental rate of the asset score or a combination thereof. In an embodiment of the present disclosure, the variation prediction-based AI model is a forecasting model that predicts the future values based on past performance. For example, the variation prediction-based AI model may be a statistical model like Autoregressive Integrated Moving Average (ARIMA), complex neural network algorithms like Convolutional Neural Network-Quantile Regression (CNN-QR), DeepAR+, Prophet, Non-Parametric Time Series (NPTS), Autoregressive Integrated Moving Average (ARIMA), Exponential Smoothing (ETS) and the like. In an embodiment of the present disclosure, CNN-QR is a proprietary machine learning technique for forecasting time series using causal CNNs. CNN-QR works best with large datasets containing hundreds of time series. It accepts item metadata and is the only forecast technique that accepts related time series data without future values. Further, the DeepAR+ is a proprietary machine learning technique for forecasting time series using recurrent neural networks (RNNs). DeepAR+ works best with large datasets containing hundreds of feature time series. The DeepAR+ accepts forward-looking related time series and item metadata. Furthermore, the Prophet is a time series forecasting technique based on an additive model where non-linear trends are fit with yearly, weekly, and daily seasonality. It works best with time series with strong seasonal effects and several seasons of historical data. The NPTS proprietary technique is a scalable, probabilistic baseline forecaster. NPTS is especially useful when working with sparse or intermittent time series. Forecast provides four algorithm variants: standard NPTS, seasonal NPTS, climatological forecaster, and seasonal climatological. Further, ARIMA is a commonly used statistical technique for time-series forecasting. ARIMA is especially useful for simple datasets with under 100 time series. Furthermore, ETS is a commonly used statistical technique for time-series forecasting. The ETS is especially useful for simple datasets with under 100 time series, and datasets with seasonality patterns. ETS computes a weighted average over all observations in the time series dataset as its prediction, with exponentially decreasing weights over time. In an embodiment of the present disclosure, the variation prediction-based AI model may include a machine learning technique to predict the rate of variation of the asset score from the one or more new events received in the real time. In an embodiment of the present disclosure, the rate of variation includes an incremental rate or a decremental rate of the asset score. In an embodiment of the present disclosure, events, their weights, and credits are assigned by hand and not randomized.

Further, in predicting the rate of variation of the asset score associated with the timings of the one or more events of the utility equipment based on the plurality of historical asset scores, one or more new events, the generated weight profile, and the generated asset score by using the variation prediction-based AI model, the method 700 includes normalizing the generated asset score for the model of the utility equipment in predefined periodic intervals based on the obtained usage data, the ambient conditions, the obtained one or more utility parameters and the one or more score parameters by using one or more normalization techniques. In an exemplary embodiment of the present disclosure, the softmax function is used as the normalization technique. In an embodiment of the present disclosure, the normalization of the weight factor helps in converting numerical values into a new range by a mathematical function. In an exemplary embodiment of the present disclosure, the one or more normalization techniques include SoftMax technique, a min-max normalization technique, Euclidean, a Z-score technique, a Box-Cox transformation technique or a combination thereof. Further, the method 700 includes generating a delta score based on the normalized asset score, the one or more new events, the generated weight profile, a Boolean vector corresponding to occurrence of the one or more new events, a weight vector corresponding to the one or more new events and a weight of usage in the generated asset score. The delta score represents change in the asset score. In an embodiment of the present disclosure, the asset score of a particular component changes when any event occurs, when climatic conditions change, with usage over the time (like every week or every month, which could be considered a scheduled change) and the like. The usage over the time may contribute to decreasing the asset score if all other things are kept static i.e., should have a negative correlation with asset score. The method 600 includes generating the new cumulative asset score based on the normalized asset score and the generated delta score. Furthermore, the method 700 includes normalizing the generated new cumulative asset score by using the one or more normalization techniques. In an embodiment of the present disclosure, the normalized new cumulative asset score is a number between 1 and 100. The method 700 includes predicting the rate of variation of the asset score associated with the timings of the one or more events of the utility equipment based on the plurality of historical asset scores, the normalized new cumulative asset score and the one or more events by using the variation prediction-based AI model. In an embodiment of the present disclosure, the asset score is normalized across similar equipment models of the same type, and the rate of variation of the asset score is predicted. Further, based on how fast it increases or decreases, the incentive is calculated.

At step 716, a health condition of the utility equipment is determined based on the generated weight profile, the generated asset score, and the predicted rate of variation by using a health condition-based AI model. In an embodiment of the present disclosure, the health condition of the utility equipment is good performance, average performance, low performance, overheated, low risk, or high risk.

At step 718, the one or more dynamic incentives associated with the one or more authenticated components, the one or more authenticated services or a combination thereof are updated dynamically based on the predicted rate of variation of the asset score and the set of dynamic incentive rules. In an embodiment of the present disclosure, the one or more incentives dynamically changes at every interval based on the predicted rate of variation of the asset score, and the set of dynamic incentive rules. In an exemplary embodiment of the present disclosure, the one or more dynamic incentives include a warranty period and one or more terms and conditions in a warranty document, a rebate, a discount, a coupon, a virtual cash, a redeem point, a price training, a resale value, or a combination thereof. For example, updating the one or more dynamic incentive include dynamically increasing the warranty period based on the incremental rate of the asset score, dynamically decreasing the warranty period based on the decremental rate of the asset score, adjusting the type of the warranty, such as powertrain or bumper to bumper, adjusting the one or more terms and conditions in the warranty document, such as extending the warranty of the parts or including labor charges, providing the one or more dynamic incentives to the one or more users, and the like. In an embodiment of the present disclosure, incentives are calculated at every predefined time period, such as 3 months, 6 months, 12 months, and the like. Th incentives are dynamic and change at every interval based on the asset score. Further, credits for each event are also calculated that shows the user that good behavior is rewarded, and bad behavior decreases the incentive value. In updating the one or more dynamic incentives associated with the one or more authenticated components, the one or more authenticated services, or a combination thereof dynamically based on the predicted rate of variation of the asset score and the set of dynamic incentive rules, the method 600 includes generating one or more credits based on the generated weight profile and the generated asset score. Further, the method 600 includes updating the one or more dynamic incentives associated with the one or more authenticated components, the one or more authenticated services, or a combination thereof dynamically based on the predicted rate of variation of the asset score, the set of dynamic incentive rules, and the generated one or more credits. For example, if the filter is supposed to be replaced in every 3 months, and if the filter is not installed at all, a negative credit is provided. When the genuine filter is installed at 3 months, a +10 credit is provided based on the weight profile. When the non-genuine filter is installed at 3 months, +3 credit is provided based on the weight profile. If the genuine filter is installed at 5th month, then +5 credit is calculated. Example table of incentive profile from the manufacturer (not limited to) is as follows:

| Asset Score | | |
|---|---|---|
| Rate of Change | Incentive | Dynamic Value (Example) |
| 5% | Warranty Period | Extended by 1 week (or 1 year) |
| 6% | Warranty Type | Silver Plan to Platinum Plan |
| 10% | Distributor Rebate | $1000 at the end of year |
| 12% | Coupon | Free Oil Service or Free |
| | | Installation |
| 30% | Discount Coupon | 20% off for next service |
| 40% | Discount Coupon | 10% of new vehicle purchase |

In an embodiment of the present disclosure, the one or more users may receive notification of one or more dynamic incentives via the monitor login or one or more electronic devices 108. In an exemplary embodiment of the present disclosure, the one or more terms and conditions may include a warranty type, a warranty scope, a warranty risk, a warranty reward, or a combination thereof. In an embodiment of the present disclosure, adjusting the one or more terms and conditions include adjusting the warranty type, the warranty scope, the warranty risk, the warranty reward, or a combination thereof. In an embodiment, the warranty period is a duration until which the manufacturer is liable for any parts and labor charges, when the machine fails. In such embodiment, the warranty period value can be extended by any time duration, such as an hour, a day, a week, a month, a quarter, or a combination thereof. In one embodiment, if the dynamic warranty is decreased for a customer, then the one or more terms and conditions such as the warranty type, the warranty length, the warranty scope, and the like are decreased based on a consent of the customer. In such a scenario, the customer is offered one or more inducements in higher multiples such as the warranty period increases by two times. In an embodiment of the present disclosure, the warranty length may be increased or decreased depending on the change in the normalized asset score. The change is dependent on the magnitude of rate of change of normalized asset score with respect to time.

At step 720, one or more notifications are generated corresponding to the updated one or more dynamic incentives.

At step 722, the generated one or more notifications, the predicted rate of variation and the determined health condition are outputted on user interface screen of the one or more electronic devices 108 associated with the one or more users via one or more communication channels. In an exemplary embodiment of the present disclosure, the one or more communication channels include a Short Message Service (SMS), a multimedia message, a push notification on mobile phone, an email, and the like. In an embodiment of the present disclosure, the predicted rate of variation is outputted in one or more visualization formats. The one or more visualization formats include charts, graphs, or a combination thereof. In another embodiment of the present disclosure, the one or more notifications of adjustment of the dynamic warranty for the model of the utility equipment may be sent via a user login onto the platform. The user may login onto the platform via a monitor.

Further, the method 600 includes generating one or more dynamic factors associated with the model of the utility equipment based on the obtained usage data, the obtained one or more utility parameters, the generated weight profile, the asset score, and the one or more score parameters. In an embodiment of the present disclosure, the one or more dynamic factors include a dynamic calculation of resale value, a dynamic dispatch of technician with the right skill set, a dynamic parts inventory of which parts to stock and which parts not stock, a dynamic technician pricing as the lower asset score demands more work from a highly skilled technician, a dynamic training so the asset score can be improved with the right training and reduce mishandling, a dynamic parts pricing of which parts are going to be more popular than others, dynamic repair recommendations as lower asset score for certain class of utility equipment might trigger faster repair recommendation or a combination thereof. In an embodiment of the present disclosure, the customer may visualize the dynamic score and the weight profile of the model of the utility equipment from a digital platform. In such embodiment, the digital platform may include a website published on a web server to depict information about the model of the utility equipment, the asset score, various weight profiles and the like. Further, the method 600 includes generating a dynamic resale value based on the generated one or more dynamic parameters, the asset score, a prior purchase price of the utility equipment and a quality of maintenance of the utility equipment. In an embodiment of the present disclosure, the dynamic resale value may be better if the one or more genuine parts are used at a right time, which in turn maintains the quality. Further, the asset score may be less if the one or more parts used in the utility equipment are not genuine which in turn degrades the quality of maintenance of the utility equipment. Furthermore, the dynamic resale value of the utility equipment may be determined for a second owner and a third owner based on the prior purchase price of the utility equipment. The method 600 includes determining an age of the utility equipment based on the generated one or more dynamic parameters, the asset score, and the quality of maintenance of the utility equipment. In an embodiment of the present disclosure, the dynamic score provides data in case of legacy equipment. Based on the determined age and algorithmic data, a certified technician having the right skills may be dispatched to replace one or more defected parts with the one or more authorized parts. Further, the asset score is also used to determine the technician's rate dynamically and cost of the overall replacement with guarantee.

Further, the method 600 includes determining a certified technician having required technical skills to replace one or more defected components with one or more authorized components based on the determined age, and the asset score. In an embodiment of the present disclosure, the asset score, the weight profile and the frequency of replacement of parts helps in determining the operator's work to operate the equipment. The method 600 includes determining service charge of the certified technician and cost of replacement with guarantee based on the determined certified technician, the asset score, the weight profile and a frequency of replacement of the one or more defected components. The method 600 includes generating one or more operator recommendations based on the determined certified technician, the asset score, the weight profile and the frequency of replacement of the one or more defected components. For example, if the operator has changed the filter 5 times more than needed, then a specific type of training personalized to the customer and the operator may be provided. Furthermore, the method 600 includes determining a dynamic part inventory and a dynamic part pricing based on the generated one or more dynamic parameters, the asset score, an exact quantity of inventory required by an Original Equipment Manufacturer (OEM) to keep in hands and an exact quantity of inventory required by an inventory distributor to keep in a warehouse. In an embodiment of the present disclosure, Just-in-time inventory may be created, such that no understock or overstock of an item takes place. Since maintenance events and parts usage data is received continuously, the right inventory may be accurately predicted based on the sensor values and asset score. In an embodiment of the present disclosure, an understocking, and an overstocking of the inventory for OEM and inventory distributors may be removed by determining the exact quantity of the inventory required in both cases. In an embodiment of the present disclosure, the dynamic part pricing is based on popularity of the component or lack of it. If a particular component is running low on inventory, then based on the asset score, the price increase of that component is suggested. The price of the part is adjusted automatically based on its frequency of changes across different models. The method 600 includes determining one or more components required to ship overnight, keep in stock or a combination thereof based on the generated one or more dynamic parameters and the asset score.

The method 600 includes determining if replacement or maintenance of the one or more authenticated components is required based on the one or more scheduled event timings, the obtained usage data, the obtained one or more utility parameters, the generated weight profile, a standard lifetime of the one or more authenticated components, the determined health condition, and the one or more score parameters. Further, the method 600 includes generating one or more notifications to replace the one or more authenticated components upon determining that the one or more authenticated components are required to be replaced. The generated one or more notifications are outputted on user interface screen of the one or more electronic devices 108 associated with the one or more users via the one or more communication channels or the one or more authenticated components. The n method 600 includes generating one or more recommendations to schedule maintenance of the one or more authenticated components upon determining that the one or more authenticated components are required to be maintained. The generated one or more recommendations are outputted on user interface screen of the one or more electronic devices 108 associated with the one or more users and one or more technician devices associated with one or more technicians via the one or more communication channels. In an embodiment of the present disclosure, alerts are sent to the one or more users for notifying a replacement of the one or more authenticated components in the utility equipment based on a pre-defined requirement. In one embodiment, the alert for the replacement may be sent based on a standard lifetime of the one or more authenticated components. Further, the scheduled maintenance event of the one or more authenticated components may be performed after a pre-defined interval of time. In another embodiment of the present disclosure, a conditional maintenance of the one or more authenticated components may depend upon the condition of the one or more authenticated components. In an embodiment of the present disclosure, the alert for the replacement of the one or more authenticated components may be sent by the one or more authenticated components itself.

The method 600 includes determining if one or more authenticated components are required to be installed on the utility equipment based on the obtained usage data, the obtained one or more utility parameters, the generated weight profile, the one or more score parameters, and a predefined component information. Further, the method 600 includes determining if the installed one or more authenticated components are one or more required authenticated components based on the predefined component information. The method 600 includes generating one or more notifications to replace the installed one or more authenticated components with the one or more required components upon determining that the installed one or more authenticated components are not the one or more required authenticated components. In an embodiment of the present disclosure, the generated one or more notifications are outputted on user interface screen of the one or more electronic devices 108 associated with the one or more users via the one or more communication channels. In an embodiment of the present disclosure, it is checked whether the one or more authenticated components are supposed to be installed on the utility equipment or not. For example, if “Filter XT” is only recommended for the utility equipment XY, and if installed, then the weight profile and the asset score is higher and if “Filter XS” is installed by mistake, then the weight profile is lower and sends an alert to the one or more users. However, the utility equipment still operates fine as both filters are still authenticated and genuine parts.

In an embodiment of the present disclosure, the method 600 includes receiving a data representative of the one or more authenticated components and status of the one or more authenticated components in form of a transaction from one or more contacts via a decentralized ledger. In an embodiment of the present disclosure, the one or more contacts correspond to network nodes of a blockchain. In an embodiment of the present disclosure, the Blockchain is used to determine the authenticity of the authenticated part. The Blockchain is used as tamper-proof, append-only database and distributed nodes to verify that a component is indeed genuine. Further, the method 600 includes verifying the transaction upon receiving approval from the network nodes through a consensus mechanism. The verified transaction represents that the one or more authenticated components are authentic. Furthermore, the method 600 includes adding the verified transaction to the blockchain upon verifying the transaction. For example, the one or more contacts, such as supplier, OEM, distributor, and the owner/operator all interact with a component at various points from manufacturing the component, tagging the component, shipping, installation and so on. Each party uses the decentralized ledger to send the data about an asset it is installed on, timestamp and hash keys that ensures it is unique and can be installed only once. Further, each party sends data about the component and its status in a transaction. Furthermore, each transaction is verified by network nodes through a consensus mechanism before being added to the blockchain.

The method 700 may be implemented in any suitable hardware, software, firmware, or combination thereof

Thus, various embodiments of the present computing system 104 provide a solution to facilitate safety management of equipment used by end customers. The computing system 104 provides dynamic warranty program to a customer by increasing and decreasing the warranty term and/or features in small increments based on usage of authenticated components by customers which not only motivates the user to handle the equipment properly but also benefits the OEMs in receiving the after sales revenue. Moreover, the present disclosed computing system 104 offers the dynamic warranty program based on detection of the one or more authenticated components which helps in identifying the uniqueness of the authorized equipment and, also usage of the one or more authenticated components in the utility equipment accurately. Furthermore, the computing system 104 utilizes artificial intelligence-based technologies to generate the asset score which determines an equipment's events at a given time and enables the OEMs or owners to quickly determine the current state of the machine and compare it with similar machines easily and effectively. In an embodiment of the present disclosure, end customers do not use authenticated and genuine parts because there is no incentive for them to use a genuine part. “Damage and Destruction” should be “downtime” of the equipment or equipment failure due to faulty part. 90% of machines fail because of bad part or untimely replacement due to human error. However, the computing system 104 perform each step programmatically, from detection to incentive, end customers are motivated to buy genuine parts. For example, a warranty of the car may increase if the user buys genuine oil filter and do oil service at an authorized dealer directly from the car company. Further, OEMs are unable to enforce usage of authenticated components as customers are free to install whatever they want. Sometimes, its voids the warranty but as soon as the warranty expires, they start using counterfeit to save cost. The computing system 104 solves this problem as when genuine parts are used, the computing system 104 detects it and programmatically gives a better incentives to the user without any human intervention. In an embodiment of the present disclosure, the computing system 104 automatically and dynamically extend the length of the warranty contract or type of warranty contract and modify the part warranty vs asset warranty. The computing system 104 also do dynamic part inventory and part pricing. Further, from the technical effect point of view, the computing system 104 reduces an expenditure on hardware side as the computing system 104 is developed on the cloud server. Also, the computing system 104 increases the processing speed as the one or more hardware processors 202 used in the computing system 104 are hosted on the cloud server. In an embodiment of the present disclosure, the softmax function is used to normalize the asset score.

Further, the computing system 104 is able to predict health condition of the equipment much in advance which prevents accidents due to malfunctioning of the equipment and ensure human safety. The computing system 104 predicts whether the equipment is a faulty equipment or a genuine equipment using AI models. This helps prevent any damage to the equipment. Moreover, the computing system 104 ensures that the equipment meets all safety standards of the industry by checking internal circuitry or components of the equipment. This helps in determining the health condition of the equipment and whether the equipment is a fake equipment, thereby alarming the end customer to buy a genuine product.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The 110 adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system to provide data-driven dynamic recommendations for equipment maintenance lifecycle, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a data detection module configured to detect at least one of: one or more authenticated components and one or more authenticated services of a utility equipment for uniqueness and compliance by scanning a unique encrypted code associated with each of the at least one of: the one or more authenticated components and the one or more authenticated services by using one or more automated detection means;
a data obtaining module configured to:
obtain usage data associated with the detected at least one of: the one or more authenticated components and the one or more authenticated services via one or more communication platforms upon detecting the at least one of: the one or more authenticated components and the one or more authenticated services, wherein the one or more communication platforms use one or more sensors to receive the usage data via one or more communication technologies;
obtain one or more utility parameters associated with the utility equipment from a storage unit and an external Application Programming Interface (API) based on the obtained usage data, wherein the one or more utility parameters comprise a model of the utility equipment, name of the utility equipment, age of the utility equipment, location of the utility equipment, temperature, humidity, speed, location, run hours, and name of user of the utility equipment;
obtain one or more events and a timing of the one or more events associated with the utility equipment from the storage unit based on the obtained usage data and the obtained one or more utility parameters, wherein the one or more events comprise at least one of: one or more periodic scheduled maintenance events, one or more repair events, one or more accident events, one or more audit events, one or more financial events and one or more routing maintenance events:
a data computation module configured to:
generate a weight profile associated with the obtained one or more events and the obtained timing of the one or more events based on a set of weight generation rules, the obtained usage data, the obtained one or more utility parameters, one or more score parameters and one or more scheduled event timings, wherein the one or more score parameters comprise at least one of: telemetry of the utility equipment, ambient conditions, one of: operator's handling skill and performance, and timely maintenance of the utility equipment from an authorized certified personnel; and
generate an asset score associated with the utility equipment based on the obtained usage data, the ambient conditions, the obtained one or more utility parameters, the generated weight profile and the one or more score parameters;
a data prediction module configured to predict a rate of variation of the asset score associated with the timings of the one or more events of the utility equipment based on a plurality of historical asset scores, one or more new events, the generated weight profile, and the generated asset score by using a variation prediction-based Artificial Intelligence (AI) model, wherein the rate of variation comprises one of: an incremental rate and a decremental rate of the asset score;
a health condition determination module configured to determine a health condition of the utility equipment based on the generated weight profile, the generated asset score, and the predicted rate of variation by using a health condition-based AI model, wherein the health condition of the utility equipment comprises one of: good performance, average performance, low performance, overheated, low risk, and high risk;
a data incentive module configured to update one or more dynamic incentives associated with the at least one of: the one or more authenticated components and the one or more authenticated services dynamically based on the predicted rate of variation of the asset score and a set of dynamic incentive rules, wherein the one or more dynamic incentives comprise at least one of: a warranty period and one or more terms and conditions in a warranty document, a rebate, a discount, a coupon, a virtual cash, a redeem point, a price training, and a resale value;
a notification generation module configured to generate one or more notifications corresponding to the updated one or more dynamic incentives; and
a data output module configured to output the generated one or more notifications, the predicted rate of variation and the determined health condition on user interface screen of one or more electronic devices associated with one or more users via one or more communication channels, wherein the one or more communication channels comprise a Short Message Service (SMS), a multimedia message, a push notification and an email.

2. The computing system of claim 1, wherein the usage data comprise at least one of: data of usage of the one or more authenticated components in a predefined time period, data of usage of the one or more authenticated services in the predefined time period, data of usage of the utility equipment in a predefined geographical location, data of installation event, data of maintenance service performed, and data of usage of the utility equipment based on guidance provided in a handbook, wherein the usage data comprises: location of the one or more authenticated components, the one or more authenticated services or a combination thereof, time of an event, and installation type, and wherein the installation type comprises factory install, replacement, repair, and regular maintenance.

3. The computing system of claim 1, wherein in generating the weight profile associated with the obtained one or more events and the obtained timing of the one or more events based on the set of weight generation rules, the obtained usage data, the obtained one or more utility parameters, the one or more score parameters and the one or more scheduled event timings, the data computation module is configured to:
determine a weight factor associated with each of the obtained one or more events based on the obtained timing of the one or more events, the set of weight generation rules, the obtained usage data, the obtained one or more utility parameters, the one or more score parameters, the one or more scheduled event timings and at least one of: historical data and anecdotal experience corresponding to the one or more events; and
generate the weight profile by assigning the determined weight factor to each of the obtained one or more events.

4. The computing system of claim 1, wherein updating the one or more dynamic incentive comprise at least one of: dynamically increasing the warranty period based on the incremental rate of the asset score, dynamically decreasing the warranty period based on the decremental rate of the asset score, adjusting the type of the warranty, adjusting one or more terms and conditions in the warranty document, and providing the one or more dynamic incentives to the one or more users, and wherein adjusting the one or more terms and conditions comprise adjusting at least one of: the warranty type, a warranty scope, a warranty risk and a warranty reward.

5. The computing system of claim 1, wherein the data computation module is configured to:
generate one or more dynamic factors associated with the utility equipment based on the obtained usage data, the obtained one or more utility parameters, the generated weight profile, the asset score, and the one or more score parameters, wherein the one or more dynamic factors comprise at least one of: a dynamic calculation of resale value, a dynamic dispatch of technician with a right skill set, a dynamic parts inventory, a dynamic technician pricing, a dynamic training, a dynamic parts pricing, and a dynamic repair recommendations;
generate a dynamic resale value based on the generated one or more dynamic parameters, the asset score, a prior purchase price of the utility equipment and a quality of maintenance of the utility equipment; and
determine an age of the utility equipment based on the generated one or more dynamic parameters, the asset score, and the quality of maintenance of the utility equipment.

6. The computing system of claim 5, wherein the data computation module is configured to:
determine a certified technician having required technical skills to replace one or more defected components with one or more authorized components based on the determined age, and the asset score;
determine a service charge of the certified technician and a cost of replacement with guarantee based on the determined certified technician, the asset score, the weight profile and a frequency of replacement of the one or more defected components;
generate one or more operator recommendations based on the determined certified technician, the asset score, the weight profile and the frequency of replacement of the one or more defected components;
determine a dynamic part inventory and a dynamic part pricing based on the generated one or more dynamic parameters, the asset score, an exact quantity of inventory required by an Original Equipment Manufacturer (OEM) to keep in hands and an exact quantity of inventory required by an inventory distributor to keep in a warehouse; and
determine one or more components required to at least one of: ship overnight and keep in stock based on the generated one or more dynamic parameters and the asset score.

7. The computing system of claim 1, wherein the notification generation module is configured to:
determine if one of: replacement and maintenance of the one or more authenticated components is required based on the one or more scheduled event timings, the obtained usage data, the obtained one or more utility parameters, the generated weight profile, a standard lifetime of the one or more authenticated components, the determined health condition, and the one or more score parameters;
generate one or more notifications to replace the one or more authenticated components upon determining that the one or more authenticated components are required to be replaced, wherein the generated one or more notifications are outputted on user interface screen of the one or more electronic devices associated with the one or more users via one of: the one or more communication channels and the one or more authenticated components; and
generate one or more recommendations to schedule maintenance of the one or more authenticated components upon determining that the one or more authenticated components are required to be maintained, wherein the generated one or more recommendations are outputted on user interface screen of the one or more electronic devices associated with the one or more users and one or more technician devices associated with one or more technicians via the one or more communication channels.

8. The computing system of claim 1, further comprising a compliance monitoring module configured to:
determine if one or more authenticated components are required to be installed on the utility equipment based on the obtained usage data, the obtained one or more utility parameters, the generated weight profile, the one or more score parameters and a predefined component information;
determine if the installed one or more authenticated components are one or more required authenticated components based on the predefined component information; and
generate one or more notifications to replace the installed one or more authenticated components with the one or more required components upon determining that the installed one or more authenticated components are not the one or more required authenticated components, wherein the generated one or more notifications are outputted on user interface screen of the one or more electronic devices associated with the one or more users via the one or more communication channels.

9. The computing system of claim 1, wherein the predicted rate of variation is outputted in one or more visualization formats, and wherein the one or more visualization formats comprise at least one of: charts and graphs.

10. The computing system of claim 1, wherein in predicting the rate of variation of the asset score associated with the timings of the one or more events of the utility equipment based on the plurality of historical asset scores, one or more new events, the generated weight profile, and the generated asset score by using the variation prediction-based AI model, the data prediction module is configured to:
normalize the generated asset score for the model of the utility equipment in predefined periodic intervals based on the obtained usage data, the ambient conditions, the obtained one or more utility parameters and the one or more score parameters by using one or more normalization techniques, wherein the one or more normalization techniques comprise at least one of: SoftMax technique, a min-max normalization technique, Euclidean, a Z-score technique and a Box-Cox transformation technique;
generate a delta score based on the normalized asset score, the one or more new events, the generated weight profile, a Boolean vector corresponding to occurrence of the one or more new events, a weight vector corresponding to the one or more new events and a weight of usage in the generated asset score;
generate a new cumulative asset score based on the normalized asset score and the generated delta score;
normalize the generated new cumulative asset score by using the one or more normalization techniques; and
predict the rate of variation of the asset score associated with the timings of the one or more events of the utility equipment based on the plurality of historical asset scores, the normalized new cumulative asset score and the one or more events by using the variation prediction-based AI model.

11. The computing system of claim 1, further comprising an authenticity determination module configured to:
receive a data representative of the one or more authenticated components and status of the one or more authenticated components in form of a transaction from one or more contacts via a decentralized ledger, wherein the one or more contacts correspond to network nodes of a blockchain;
verify the transaction upon receiving approval from the network nodes through a consensus mechanism, wherein the verified transaction represents that the one or more authenticated components are authentic; and
add the verified transaction to the blockchain upon verifying the transaction.

12. The computing system of claim 1, wherein in updating the one or more dynamic incentives associated with the at least one of: the one or more authenticated components and the one or more authenticated services dynamically based on the predicted rate of variation of the asset score and the set of dynamic incentive rules, the data incentive module is configured to: generate one or more credits based on the generated weight profile and the generated asset score;
update the one or more dynamic incentives associated with the at least one of: the one or more authenticated components and the one or more authenticated services dynamically based on the predicted rate of variation of the asset score, the set of dynamic incentive rules, and the generated one or more credits.

13. A method to provide data-driven dynamic recommendations for equipment maintenance lifecycle, the method comprising:
detecting, by one or more hardware processors, at least one of: one or more authenticated components and one or more authenticated services of a utility equipment for uniqueness and compliance by scanning a unique encrypted code associated with each of the at least one of: the one or more authenticated components and the one or more authenticated services by using one or more automated detection means;
obtaining, by the one or more hardware processors, usage data associated with the detected at least one of: the one or more authenticated components and the one or more authenticated services via one or more communication platforms upon detecting the at least one of: the one or more authenticated components and the one or more authenticated services, wherein the one or more communication platforms use one or more sensors to receive the usage data via one or more communication technologies;
obtaining, by the one or more hardware processors, one or more utility parameters associated with the utility equipment from a storage unit and an external API based on the obtained usage data, wherein the one or more utility parameters comprise a model of the utility equipment, name of the utility equipment, age of the utility equipment, location of the utility equipment, temperature, humidity, speed, location, run hours, and name of user of the utility equipment;
obtaining, by the one or more hardware processors, one or more events and a timing of the one or more events associated with the utility equipment from the storage unit based on the obtained usage data and the obtained one or more utility parameters, wherein the one or more events comprise at least one of: one or more periodic scheduled maintenance events, one or more repair events, one or more accident events, one or more audit events, one or more financial events and one or more routing maintenance events;
generating, by the one or more hardware processors, a weight profile associated with the obtained one or more events and the obtained timing of the one or more events based on a set of weight generation rules, the obtained usage data, the obtained one or more utility parameters, one or more score parameters and one or more scheduled event timings, wherein the one or more score parameters comprise at least one of: telemetry of the utility equipment, ambient conditions, one of: operator's handling skill and performance and timely maintenance of the utility equipment from an authorized certified personnel;
generating, by one or more hardware processors, an asset score associated with the utility equipment based on the obtained usage data, the ambient conditions, the obtained one or more utility parameters, the generated weight profile and the one or more score parameters;
predicting, by one or more hardware processors, a rate of variation of the asset score associated with the timings of the one or more events of the utility equipment based on a plurality of historical asset scores, one or more new events, the generated weight profile, and the generated asset score by using a variation prediction-based Artificial Intelligence (AI) model, wherein the rate of variation comprises one of: an incremental rate and a decremental rate of the asset score;
determining, by one or more hardware processors, a health condition of the utility equipment based on the generated weight profile, the generated asset score, and the predicted rate of variation by using a health condition-based AI model, wherein the health condition of the utility equipment comprises one of good performance, average performance, low performance, overheated, low risk, and high risk;
updating, by the one or more hardware processors, one or more dynamic incentives associated with the at least one of: the one or more authenticated components and the one or more authenticated services dynamically based on the predicted rate of variation of the asset score and a set of dynamic incentive rules, wherein the one or more dynamic incentives comprise at least one of: a warranty period and one or more terms and conditions in a warranty document, a rebate, a discount, a coupon, a virtual cash, a redeem point, a price training, and a resale value;
generating, by the one or more hardware processors, one or more notifications corresponding to the updated one or more dynamic incentives; and
outputting, by the one or more hardware processors, the generated one or more notifications, the predicted rate of variation and the determined health condition on user interface screen of one or more electronic devices associated with one or more users via one or more communication channels, wherein the one or more communication channels comprise a Short Message Service (SMS), a multimedia message, a push notification and an email.

14. The method of claim 13, wherein the usage data comprise at least one of: data of usage of the one or more authenticated components in a predefined time period, data of usage of the one or more authenticated services in the predefined time period, data of usage of the utility equipment in a predefined geographical location, data of installation event, data of maintenance service performed, and data of usage of the utility equipment based on guidance provided in a handbook, wherein the usage data comprises: location of the one or more authenticated components, the one or more authenticated services or a combination thereof, time of an event, and installation type, and wherein the installation type comprises factory install, replacement, repair, and regular maintenance.

15. The method of claim 13, wherein generating the weight profile associated with the obtained one or more events and the obtained timing of the one or more events based on the set of weight generation rules, the obtained usage data, the obtained one or more utility parameters, the one or more score parameters and the one or more scheduled event timings comprises:
determining a weight factor associated with each of the obtained one or more events based on the obtained timing of the one or more events, the set of weight generation rules, the obtained usage data, the obtained one or more utility parameters, the one or more score parameters, the one or more scheduled event timings and at least one of: historical data and anecdotal experience corresponding to the one or more events; and
generating the weight profile by assigning the determined weight factor to each of the obtained one or more events.

16. The method of claim 13, wherein updating the one or more dynamic incentive comprise at least one of: dynamically increasing the warranty period based on the incremental rate of the asset score, dynamically decreasing the warranty period based on the decremental rate of the asset score, adjusting the type of the warranty, adjusting one or more terms and conditions in the warranty document, and providing the one or more dynamic incentives to the one or more users, and wherein adjusting the one or more terms and conditions comprise adjusting at least one of: the warranty type, a warranty scope, a warranty risk and a warranty reward.

17. The method of claim 13, further comprising:
generating one or more dynamic factors associated with the utility equipment based on the obtained usage data, the obtained one or more utility parameters, the generated weight profile, the asset score, and the one or more score parameters, wherein the one or more dynamic factors comprise at least one of: a dynamic calculation of resale value, a dynamic dispatch of technician with a right skill set, a dynamic parts inventory, a dynamic technician pricing, a dynamic training, a dynamic parts pricing, and a dynamic repair recommendations;
generating a dynamic resale value based on the generated one or more dynamic parameters, the asset score, a prior purchase price of the utility equipment and a quality of maintenance of the utility equipment; and
determining an age of the utility equipment based on the generated one or more dynamic parameters, the asset score, and the quality of maintenance of the utility equipment.

18. The method of claim 17, further comprising:
determining a certified technician having required technical skills to replace one or more defected components with one or more authorized components based on the determined age, and the asset score;
determining a service charge of the certified technician and a cost of replacement with guarantee based on the determined certified technician, the asset score, the weight profile and a frequency of replacement of the one or more defected components;
generating one or more operator recommendations based on the determined certified technician, the asset score, the weight profile and the frequency of replacement of the one or more defected components;
determining a dynamic part inventory and a dynamic part pricing based on the generated one or more dynamic parameters, the asset score, an exact quantity of inventory required by an Original Equipment Manufacturer (OEM) to keep in hands and an exact quantity of inventory required by an inventory distributor to keep in a warehouse; and
determining one or more components required to at least one of: ship overnight and keep in stock based on the generated one or more dynamic parameters and the asset score.

19. The method of claim 13, further comprising:
determining if one of: replacement and maintenance of the one or more authenticated components is required based on the one or more scheduled event timings, the obtained usage data, the obtained one or more utility parameters, the generated weight profile, a standard lifetime of the one or more authenticated components, the determined health condition, and the one or more score parameters;
generating one or more notifications to replace the one or more authenticated components upon determining that the one or more authenticated components are required to be replaced, wherein the generated one or more notifications are outputted on user interface screen of the one or more electronic devices associated with the one or more users via one of: the one or more communication channels and the one or more authenticated components; and
generating one or more recommendations to schedule maintenance of the one or more authenticated components upon determining that the one or more authenticated components are required to be maintained, wherein the generated one or more recommendations are outputted on user interface screen of the one or more electronic devices associated with the one or more users and one or more technician devices associated with one or more technicians via the one or more communication channels.

20. The method of claim 13, further comprising:
determining if one or more authenticated components are required to be installed on the utility equipment based on the obtained usage data, the obtained one or more utility parameters, the generated weight profile, the one or more score parameters and a predefined component information;
determining if the installed one or more authenticated components are one or more required authenticated components based on the predefined component information; and
generating one or more notifications to replace the installed one or more authenticated components with the one or more required components upon determining that the installed one or more authenticated components are not the one or more required authenticated components, wherein the generated one or more notifications are outputted on user interface screen of the one or more electronic devices associated with the one or more users via the one or more communication channels.

21. The method of claim 13, wherein the predicted rate of variation is outputted in one or more visualization formats, and wherein the one or more visualization formats comprise at least one of: charts and graphs.

22. The method of claim 13, wherein predicting the rate of variation of the asset score associated with the timings of the one or more events of the utility equipment based on the plurality of historical asset scores, one or more new events, the generated weight profile, and the generated asset score by using the variation prediction-based AI model comprising:
normalizing the generated asset score for the model of the utility equipment in predefined periodic intervals based on the obtained usage data, the ambient conditions, the obtained one or more utility parameters and the one or more score parameters by using one or more normalization techniques, wherein the one or more normalization techniques comprise at least one of: SoftMax technique, a min-max normalization technique, Euclidean, a Z-score technique and a Box-Cox transformation technique;
generating a delta score based on the normalized asset score, the one or more new events, the generated weight profile, a Boolean vector corresponding to occurrence of the one or more new events, a weight vector corresponding to the one or more new events and a weight of usage in the generated asset score;
generating a new cumulative asset score based on the normalized asset score and the generated delta score;
normalizing the generated new cumulative asset score by using the one or more normalization techniques; and
predicting the rate of variation of the asset score associated with the timings of the one or more events of the utility equipment based on the plurality of historical asset scores, the normalized new cumulative asset score and the one or more events by using the variation prediction-based AI model.

23. The method of claim 13, further comprising:
receiving a data representative of the one or more authenticated components and status of the one or more authenticated components in form of a transaction from one or more contacts via a decentralized ledger, wherein the one or more contacts correspond to network nodes of a blockchain;
verifying the transaction upon receiving approval from the network nodes through a consensus mechanism, wherein the verified transaction represents that the one or more authenticated components are authentic; and
adding the verified transaction to the blockchain upon verifying the transaction.

24. The method of claim 13, wherein updating the one or more dynamic incentives associated with the at least one of the one or more authenticated components and the one or more authenticated services dynamically based on the predicted rate of variation of the asset score and the set of dynamic incentive rules includes:
generating one or more credits based on the generated weight profile and the generated asset score; and
updating the one or more dynamic incentives associated with the at least one of: the one or more authenticated components and the one or more authenticated services dynamically based on the predicted rate of variation of the asset score, the set of dynamic incentive rules, and the generated one or more credits.

25. A non-transitory computer-readable storage medium having instructions stored therein that, when executed by a hardware processor, cause the processor to perform method steps comprising:
detecting at least one of: one or more authenticated components and one or more authenticated services of a utility equipment for uniqueness and compliance by scanning a unique encrypted code associated with each of the at least one of: the one or more authenticated components and the one or more authenticated services by using one or more automated detection means;
obtaining usage data associated with the detected at least one of: the one or more authenticated components and the one or more authenticated services via one or more communication platforms upon detecting the at least one of: the one or more authenticated components and the one or more authenticated services, wherein the one or more communication platforms use one or more sensors to receive the usage data via one or more communication technologies;
obtaining one or more utility parameters associated with the utility equipment from a storage unit and an external Application Programming Interface (API) based on the obtained usage data, wherein the one or more utility parameters comprise a model of the utility equipment, name of the utility equipment, age of the utility equipment, location of the utility equipment, temperature, humidity, speed, location, run hours, and name of user of the utility equipment;
obtaining one or more events and a timing of the one or more events associated with the utility equipment from the storage unit based on the obtained usage data and the obtained one or more utility parameters, wherein the one or more events comprise at least one of: one or more periodic scheduled maintenance events, one or more repair events, one or more accident events, one or more audit events, one or more financial events and one or more routing maintenance events;
generating a weight profile associated with the obtained one or more events and the obtained timing of the one or more events based on a set of weight generation rules, the obtained usage data, the obtained one or more utility parameters, one or more score parameters and one or more scheduled event timings, wherein the one or more score parameters comprise at least one of: telemetry of the utility equipment, ambient conditions, one of: operator's handling skill and performance and timely maintenance of the utility equipment from an authorized certified personnel;
generating an asset score associated with the utility equipment based on the obtained usage data, the ambient conditions, the obtained one or more utility parameters, the generated weight profile and the one or more score parameters;
predicting a rate of variation of the asset score associated with the timings of the one or more events of the utility equipment based on a plurality of historical asset scores, one or more new events, the generated weight profile, and the generated asset score by using a variation prediction-based Artificial Intelligence (AI) model, wherein the rate of variation comprises one of: an incremental rate and a decremental rate of the asset score;
determining a health condition of the utility equipment based on the generated weight profile, the generated asset score, and the predicted rate of variation by using a health condition-based AI model, wherein the health condition of the utility equipment comprises one of: good performance, average performance, low performance, overheated, low risk, and high risk;
updating one or more dynamic incentives associated with the at least one of; the one or more authenticated components and the one or more authenticated services dynamically based on the predicted rate of variation of the asset score and a set of dynamic incentive rules, wherein the one or more dynamic incentives comprise at least one of: a warranty period and one or more terms and conditions in a warranty document, a rebate, a discount, a coupon, a virtual cash, a redeem point, a price training, and a resale value;
generating one or more notifications corresponding to the updated one or more dynamic incentives; and
outputting the generated one or more notifications, the predicted rate of variation and the determined health condition on user interface screen of one or more electronic devices associated with one or more users via one or more communication channels, wherein the one or more communication channels comprise a Short Message Service (SMS), a multimedia message, a push notification and an email.

26. The non-transitory computer-readable storage medium of claim 29, wherein the usage data comprise at least one of: data of usage of the one or more authenticated components in a predefined time period, data of usage of the one or more authenticated services in the predefined time period, data of usage of the utility equipment, data of installation event, data of maintenance service performed, and data of usage of the utility equipment based on guidance provided in a handbook.
